(19) United States
(12) Patent Application Publication
(10) Pub. No.: US 2007/0055546 A1
(43) Pub. Date: Mar. 8, 2007

(54) Data techniques related to tissue coding

(75) Inventors: Edward K.Y. Jung, Bellevue, WA (US); Robert W. Lord, Seattle, WA (US); Lowell L. Wood JR., Livermore, CA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC, a limited liability corporation of State of Delawre

(21) Appl. No.: 11/471,289

(22) Filed: Jun. 19, 2006

Related U.S. Application Data
(63) Continuation-in-part of application No. 11/222,031, filed on Sep. 8, 2005.
(63) Continuation-in-part of application No. 11/241,868, filed on Sep. 30, 2005.
(63) Continuation-in-part of application No. 11/262,499, filed on Oct. 28, 2005.
(63) Continuation-in-part of application No. 11/286,133, filed on Nov. 23, 2005.
(63) Continuation-in-part of application No. 11/311,906, filed on Dec. 19, 2005.
(63) Continuation-in-part of application No. 11/314,730, filed on Dec. 21, 2005.
(63) Continuation-in-part of application No. 11/343,965, filed on Jan. 31, 2006.
(63) Continuation-in-part of application No. 11/347,804, filed on Feb. 3, 2006.
(63) Continuation-in-part of application No. 11/362,545, filed on Feb. 24, 2006.

(51) Int. Cl. G06Q 10/00

(52) U.S. Cl. 705/2

(57) ABSTRACT

An apparatus, device, methods, computer program product, and system are described that define an association between at least two instances of at least one treatment parameter and at least one instance of at least one treatment characteristic, the at least one treatment parameter including at least one target-related tissue ancestry-correlated binding site, and the at least one treatment characteristic including at least one target-related tissue ancestry-correlated binding agent, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor, and that assign the association to at least one memory.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC § 119(e) for provisional patent applications, for any and all parent, grandparent, great-grandparent, etc. applications of the Related Application(s)).

Related Applications:

For purposes of the USPTO extra-statutory requirements, the present application constitutes a continuation-in-part of U.S. patent application Ser. No. 11/222,031, entitled Data Techniques Related To Tissue Coding, naming Edward K. Y. Jung, Robert W. Lord and Lowell L. Wood, Jr., as inventors, filed 8 Sep. 2005, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/241,868 entitled Data Techniques Related to Tissue Coding, naming Edward K. Y. Jung, Robert W. Lord, and Lowell L. Wood, Jr., as inventors, filed 30 Sep. 2005, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/262,499, entitled Accessing Data Related to Tissue Coding, naming Edward K. Y. Jung, Robert W. Lord, and Lowell L. Wood, Jr., as inventors, filed 28 Oct. 2005, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/286,133, entitled Accessing Data Related to Tissue Coding, naming Edward K. Y. Jung, Robert W. Lord, and Lowell L. Wood, Jr., as inventors, filed 23 Nov. 2005, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/311,906, entitled Accessing Predictive Data, naming Edward K. Y. Jung, Royce A. Levien, Robert W. Lord, Mark A. Malamud, John D. Rinaldo Jr., and Lowell L. Wood, Jr., as inventors, filed 19 Dec. 2005, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/314,730, entitled Accessing Predictive Data, naming Edward K. Y. Jung, Royce A. Levien, Robert W. Lord, Mark A. Malamud, John D. Rinaldo Jr., and Lowell L. Wood, Jr., as inventors, filed 21 Dec. 2005, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/343,965, entitled Accessing Predictive Data, naming Edward K. Y. Jung, Royce A. Levien, Robert W. Lord, Mark A. Malamud, John D. Rinaldo Jr., and Lowell L. Wood, Jr., as inventors, filed 31 Jan. 2006, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/347,804, entitled Filtering Predictive Data, naming Edward K. Y. Jung, Royce A. Levien, Robert W. Lord, Mark A. Malamud, John D. Rinaldo Jr., and Lowell L. Wood, Jr., as inventors, filed 3 Feb. 2006, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/362,545, entitled Search Techniques Related To Tissue Coding, naming Edward K. Y. Jung, Royce A. Levien, Robert W. Lord, Mark A. Malamud, John D. Rinaldo Jr., and Lowell L. Wood, Jr., as inventors, filed 24 Feb. 2006, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present applicant entity has provided above a specific reference to the application(s)from which priority is being claimed as recited by statute. Applicant entity understands that the statute is unambiguous in its specific reference language and does not require either a serial number or any characterization, such as “continuation” or “continuation-in-part,” for claiming priority to U.S. patent applications. Notwithstanding the foregoing, applicant entity understands that the USPTO's computer programs have certain data entry requirements, and hence applicant entity is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Application and of any and all parent, grandparent, great-grandparent, etc. applications of the Related Applications is incorporated herein by reference to the extent such subject matter is not inconsistent herewith.

### TECHNICAL FIELD

This description relates to data handling techniques.

### SUMMARY

An embodiment provides a method. In one implementation, the method includes but is not limited to defining an association between at least two instances of at least one treatment parameter and at least one instance of at least one treatment characteristic, the at least one treatment parameter including at least one target-related tissue ancestry-correlated binding site, and the at least one treatment characteristic including at least one target-related tissue ancestry-correlated binding agent, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor. The method further includes but is not limited to assigning the association to at least one memory. In addition to the foregoing, other method aspects are described in the claims, drawings, and text forming a part of the present disclosure.

An embodiment provides a computer program product. In one implementation, the computer program product includes but is not limited to a signal bearing medium bearing at least one of one or more instructions for defining an association between at least two instances of at least one treatment parameter and at least one instance of at least one treatment characteristic, the at least one treatment parameter including at least one target-related tissue ancestry-correlated binding site, and the at least one treatment characteristic including at least one target-related tissue ancestry-correlated binding agent, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor, and the signal bearing medium bearing one or more instructions for assigning the association to at least one memory. In addition to the foregoing, other computer program product aspects are described in the claims, drawings, and text forming a part of the present disclosure.

An embodiment provides a system. In one implementation, the system includes but is not limited to a computing device and instructions. The instructions when executed on the computing device cause the computing device to define an association between at least two instances of at least one treatment parameter and at least one instance of at least one treatment characteristic, where the at least one treatment parameter includes at least one target-related tissue ancestry-correlated binding site, and where the at least one treatment characteristic includes at least one target-related tissue ancestry-correlated binding agent, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor, and to assign the association to at least one memory. In addition to the foregoing, other system aspects are described in the claims, drawings, and text forming a part of the present disclosure.

An embodiment provides a device. In one implementation, the device includes but is not limited to a treatment system, the treatment system comprising treatment logic that is operable to define an association between at least two instances of at least one treatment parameter and at least one instance of at least one treatment characteristic, the at least one treatment parameter including at least one target-related tissue ancestry-correlated binding site, and the at least one treatment characteristic including at least one target-related tissue ancestry-correlated binding agent, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor. The treatment system further includes a treatment data memory that is operable to store the association. In addition to the foregoing, other device aspects are described in the claims, drawings, and text forming a part of the present disclosure.

An embodiment provides another method. In one implementation, the method includes but is not limited to defining an association between at least two instances of at least one treatment parameter and at least one instance of at least one treatment characteristic, where the at least one treatment parameter includes at least one target-related tissue ancestry-correlated binding site, and where the at least one treatment characteristic includes at least one target-related tissue ancestry-correlated binding agent, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor. In addition to the foregoing, other method aspects are described in the claims, drawings, and text forming a part of the present disclosure.

An embodiment provides another method. In one implementation, the method includes but is not limited to defining an association between at least two instances of at least one treatment parameter and at least one instance of at least one treatment characteristic, where the at least one treatment parameter includes at least one target-related tissue ancestry-correlated binding agent, and where the at least one treatment characteristic includes at least one target-related tissue ancestry-correlated binding site, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor. The method further includes but is not limited to assigning the association to at least one memory. In addition to the foregoing, other method aspects are described in the claims, drawings, and text forming a part of the present disclosure.

In addition to the foregoing, various other embodiments are set forth and described in the text (e.g., claims and/or detailed description) and/or drawings of the present description.

The foregoing is a summary and thus contains, by necessity, simplifications, generalizations and omissions of detail; consequently, those skilled in the art will appreciate that the summary is illustrative only and is not intended to be in any way limiting. Other aspects, features, and advantages of the devices and/or processes described herein, as defined by the claims, will become apparent in the detailed description set forth herein.

### BRIEF DESCRIPTION OF THE DRAWINGS

FIG. 1 illustrates an example clinical system in which embodiments may be implemented, perhaps in a device.

FIG. 2 illustrates certain alternative embodiments of the clinical system of FIG. 1.

FIG. 3 illustrates an alternative embodiment of treatment data associated with the clinical system of FIG. 1.

FIG. 4 illustrates another alternative embodiment of treatment data associated with the clinical system of FIG. 1.

FIG. 5 illustrates another alternative embodiment of treatment data associated with the clinical system of FIG. 1, with specific examples of treatment data.

FIG. 6 illustrates additional alternative embodiments of treatment data associated with the clinical system of FIG. 1, with specific examples of treatment data.

FIG. 7 illustrates additional alternative embodiments of treatment data associated with the clinical system of FIG. 1, with specific examples of treatment data.

FIG. 8 illustrates an operational flow representing example operations related to data techniques for tissue coding.

FIG. 9 illustrates an alternative embodiment of the example operational flow of FIG. 8.

FIG. 10 illustrates an alternative embodiment of the example operational flow of FIG. 8.

FIG. 11 illustrates an alternative embodiment of the example operational flow of FIG. 8.

FIG. 12 illustrates an alternative embodiment of the example operational flow of FIG. 8.

FIG. 13 illustrates an alternative embodiment of the example operational flow of FIG. 8.

FIG. 14 illustrates an alternative embodiment of the example operational flow of FIG. 8.

FIG. 15 illustrates an alternative embodiment of the example operational flow of FIG. 8.

FIG. 16 illustrates an alternative embodiment of the example operational flow of FIG. 8.

FIG. 17 illustrates an alternative embodiment of the example operational flow of FIG. 8.

FIG. 18 illustrates a partial view of an example computer program product that includes a computer program for executing a computer process on a computing device.

FIG. 19 illustrates an example device in which embodiments may be implemented.

FIG. 20 illustrates another operational flow representing example operations related to data techniques for tissue coding.

FIG. 21 illustrates an operational flow representing example operations related to data techniques for tissue coding.

FIG. 22 illustrates an alternative embodiment of the example operational flow of FIG. 21.

FIG. 23 illustrates an alternative embodiment of the example operational flow of FIG. 21.

The use of the same symbols in different drawings typically indicates similar or identical items.

### DETAILED DESCRIPTION

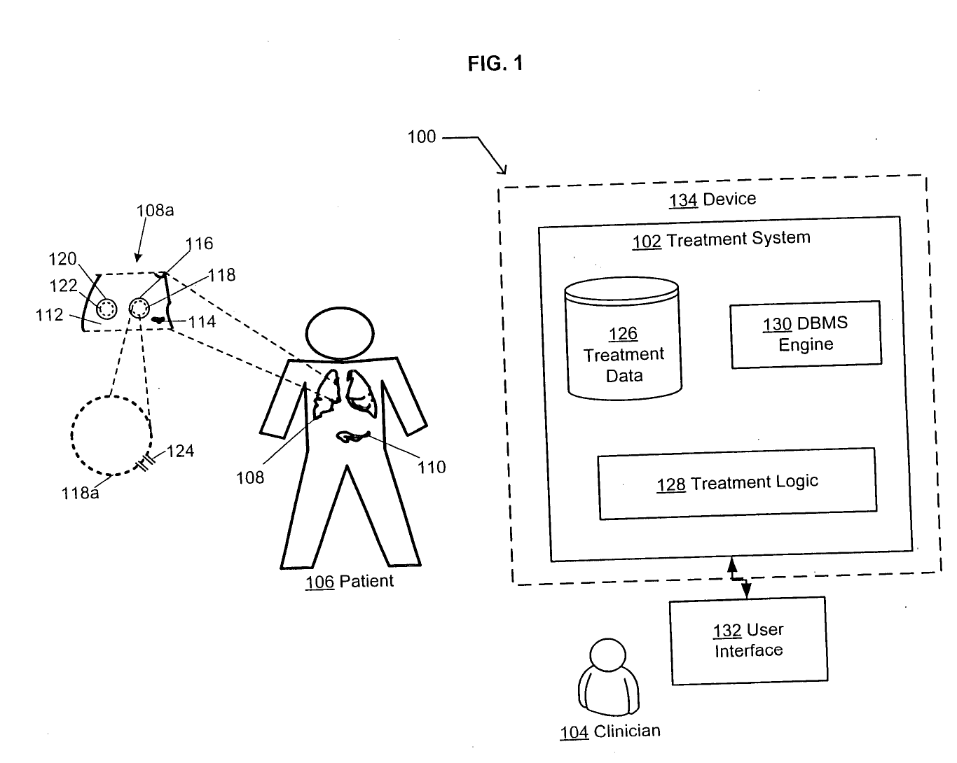

FIG. 1 illustrates an example clinical system 100 in which embodiments may be implemented. The clinical system 100 includes a treatment system 102. The treatment system 102 may be used, for example, to store, recall, access, implement, or otherwise use information that is beneficial in a clinical setting(s). For example, the treatment system 102 may be used to diagnose or treat patients by storing and/or providing information as to whether or how treatment agent(s) may be applied to a specific region(s) of interest of the human body, such as, for example, a lobe of the lungs, breast tissue, cancerous tissue at a certain bodily location, or other such regions of interest. As a further example, the treatment system 102 may provide information as to whether and/or how to minimize or avoid application of such treatment agents to regions of non-interest (for example, regions to which the treatment agent(s) should not be applied, in order to avoid, e.g., problematic side effects and other undesired results). On the basis of such clinical information, for example, targeted applications of treatment agents (e.g., medication, imaging agents, or other beneficial medical agents) may be carried out in a manner that achieves a desired outcome, while minimizing or eliminating unwanted applications to non-targeted bodily regions.

In FIG. 1, the treatment system 102 is used by a clinician 104. The clinician 104 may, for example, use the treatment system 102 to enter, store, request, or access clinical information such as, for example, the various examples provided herein. The clinician 104 may generally represent, for example, any person involved in health care, including, for example, a doctor, a nurse, a physician's assistant, or a medical researcher. The clinician 104 also may represent someone who is involved in health care in the sense of developing, managing, or implementing the treatment system 102, e.g., a software developer with clinical knowledge (or access to clinical knowledge), a database manager, or an information technologies specialist. Even more generally, some or all of various functions or aspects described herein with respect to the clinician 104 may be performed automatically, e.g., by an appropriately-designed and implemented computing device, or by software agents or other automated techniques.

A patient 106 generally represents any person with an illness, injury, or disease, or who is thought to potentially have such an illness, injury, or disease, or who may be wholly or partially healthy but who is nonetheless studied in order to determine information about such an illness, injury, or disease. The patient 106 also may represent or include other diagnostic and/or animal subjects that may be used in order, for example, to determine an efficacy of a particular medication or treatment, specific examples of which are provided herein. The patient 106 may represent a particular patient in a given clinical setting, such as in a doctor's office, or in a hospital, who is to be diagnosed and/or treated using the treatment system 102. The patient 106 also may represent the more abstract notion of a class of patients (e.g., patients having a certain age, gender, race, genetic makeup, or disposition to illness or disease), or, even more generally, may represent the general notion of a generic patient during basic research and/or development or application of various medical treatments or procedures.

As such, the patient 106 generally possesses or is associated with, for example, some or all of the various organs, systems, organ systems, organ subsystems, diseased tissue, and/or healthy tissue that may be found in the body. In FIG. 1, the patient 106 is illustrated as having a lung 108 and a pancreas 110, so that these (and other) body parts may be used as the bases for the specific examples given herein. Of course, many other applications of the treatment system 102 exist, over and above the examples provided herein.

In an exploded portion 108a of the lung 108, various example elements are illustrated, although not drawn to scale for the purposes of clarity and ease of illustration and description. For example, the lung 108 may include a healthy tissue portion 112, and a diseased tissue portion 114. The healthy tissue 112 may include, for example, healthy lung tissue, while the diseased tissue 114 may include, for example, a tumor or other cancerous tissue.

The lung 108 also may include a blood vessel 116, which is illustrated in a cut-away view, and which includes a tissue component 118 known as, by way of example nomenclature, the endothelium, endothelium layer, or endothelial cells. The endothelium layer 118 generally refers to a single cell wall that lines an interior of the blood vessel 116. In FIG. 1, the blood vessel 116 and the endothelium layer 118 are illustrated as being in the vicinity of the diseased tissue 114. In contrast, an example of a blood vessel 120 is illustrated that contains endothelium layer 122. The blood vessel 120 is shown as being in the vicinity of the healthy tissue 112 of the lung 108.

Certain properties of the endothelium layer 118 and the endothelium layer 122 may enable the targeted delivery of one or more treatment agents to a vicinity of the diseased tissue 114 and the healthy tissue 112, respectively. For example, blood (and other cells) will be transported within and along a length of the blood vessel 116, where the length of the blood vessel 116 naturally extends a relatively long distance in either direction toward/away from the diseased tissue 114. However, cells of the endothelium layer 118 that have developed and/or grown over a period of time in a vicinity of the diseased tissue 114 may exhibit characteristics that are unique, or essentially unique, to a site on the endothelium layer 118 in that particular vicinity.

For example, the diseased tissue 114 may include a tumor that has grown over a period of time. During that period of time, a corresponding growth or development of a site on the endothelium layer 118 may reflect, or otherwise be correlated with and/or affected by, the growth of the diseased tissue (tumor) 114. This correlation between the history or ancestry of the site on the endothelium layer 118 in the vicinity of the diseased tissue 114 may result in unique, or almost unique, properties of the tissue ancestry-correlated site, such as, for example, a display of specific and identifiable proteins. Moreover, similar comments may apply to a tissue ancestry-correlated site along the endothelium layer 122 of the blood vessel 120, in the vicinity of the healthy tissue 112. In this way, each such tissue ancestry-correlated site, whether in the lung or in other sites in the body, may be used to provide, effectively, a molecular-level address that specifies a location within the body, e.g., a location of the diseased tissue 114 and/or the healthy tissue 112.

Accordingly, such tissue ancestry-correlated sites may be used to direct treatment agents (such as, for example, medications, imaging agents, or radio-immunotherapy agents) in a desired fashion. For example, as described in more detail in certain examples provided herein, radionuclides may be applied to the diseased tissue 114.

In this regard, it should be understood that, without use of the tissue ancestry-correlated site(s) described herein, it may be difficult to direct such treatment agents to desired body regions with a necessary or desired level of accuracy. For example, many treatment agents may be delivered by injection (or by other delivery modalities, e.g., swallowing or absorption through the skin) into a bloodstream of the patient 106. However, without an effective way to direct the treatment agents once in the bloodstream, a positive impact of the treatment agents may be reduced or eliminated. Moreover, ancillary delivery of the treatment agents to undesired regions (e.g., delivery of radionuclides to the healthy tissue 112 and/or to the pancreas 110 or other organs) may result in harm to the patient 106. Such harm may be particularly acute or problematic in cases where, for example, a concentration, dosage, or amount of the treatment agent in the bloodstream is required to be increased relative to an optimal treatment amount, simply to ensure that some portion of the treatment agent reaches and affects a desired end target. Similar comments may apply to other treatment modalities. For example, treatment of the diseased tissue 114 (e.g., a tumor) may be performed by radiation therapy in which the patient is exposed to radiation, and, again, the net effect of such treatment(s) may be negative due to harm caused by the radiation to the healthy tissue 112.

As just described, then, tissue ancestry-correlated sites may exist within and along the endothelium layers 118 and/or 122, in the vicinity of correlated tissues that may serve as target(s) (e.g., the diseased tissue 114) for certain treatment agent(s). For example, these target-related tissue ancestry-correlated sites may include, as described herein, certain proteins that may be known to bind to/with certain other agents. In one specific example discussed herein, a target-related tissue ancestry-correlated binding site includes a protein, aminopeptidase-P (APP), that is known to bind with an agent such as, for example, I-labeled monoclonal antibodies. If a treatment agent (such as, for example, radionuclides) is associated with the target-related tissue ancestry-correlated binding agent (e.g., the I-labeled monoclonal antibodies), then injection of the target-related tissue ancestry-correlated binding agent into the bloodstream will result in delivery of the treatment agent (e.g., radionuclides) to the target-related tissue ancestry-correlated binding site (e.g., APP in the vicinity of the lung 108). That is, as the target-related tissue ancestry-correlated binding agent moves through the bloodstream, the target-related tissue ancestry-correlated binding agent will bind with the target-related tissue ancestry-correlated binding site in the vicinity of the, in this example, diseased tissue 114, thus resulting in effective application of the attached treatment agent in the desired region of the body of the patient 106.

In many cases, delivery of the treatment agent(s) to the vicinity of desired body regions, by delivering the treatment agents to defined sites along a blood vessel wall(s) in the desired vicinity, may be sufficient to obtain a desired result, even if the treatment agents are continually contained within the blood vessel(s) at the target-related tissue ancestry-correlated binding sites. In various cases, treatment agent delivery should occur with greater or lesser levels of specificity and/or efficacy. For example, in some cases, it may be sufficient to provide the treatment agent in the lung 108, while in other cases the treatment agent must or should be applied substantially only to the diseased tissue 114.

Additionally, in some cases, it may be possible and/or desirable to breach or penetrate a wall of the blood vessel(s) 116/120, in order to reach associated tissue(s) directly. For example, in FIG. 1, an enlarged view 11 8a of the endothelium layer 11 8 is illustrated that includes a mechanism by which the treatment agents may directly access a direct end target of tissue (e.g., the diseased tissue 114). Specifically, FIG. 1 illustrates a mechanism 124 that may include, for example, structures known as caveolae. Although the mechanism (e.g., caveolae) 124 are shown conceptually in FIG. 1 as tubes or access points, caveolae generally refer to small invaginations of a surface of the blood vessel 116 that carry out certain transport and/or signaling functions between cells within the blood vessel 116 and cells outside of the blood vessel 116 (e.g., the diseased tissue 114). Further discussion regarding caveolae 124 is provided in various examples, herein.

Although many other examples are provided herein and with reference to the various figures, it should be understood that many types and instances of treatment data may play a role in the use and application of the various concepts referenced above and described in more detail herein. The treatment system 102 may store such treatment data in a database 126 or other memory, for easy, convenient, and effective access by the clinician 104.

The treatment data 126 may include, for example, not only the target-related tissue ancestry-correlated binding site(s) and/or the related target-related tissue ancestry-correlated binding agent(s), but also various other parameters and/or characteristics related to treatment of the patient 106, examples of which are provided herein. Through detailed storage, organization, and use of the treatment data 126, the clinician 104 may be assisted in determining optimal treatment techniques for the patient 106, in order, for example, to select and deliver an appropriate type and/or level of a treatment agent, with an appropriate degree of accuracy, to a desired end target (based on an appropriate target-related tissue ancestry-correlated binding site and/or an appropriate target-related tissue ancestry-correlated binding agent), while minimizing any negative impact of such a selection/delivery, if any, on other regions of the body of the patient 106. Ordered assignment and/or storage of information within the treatment data 126, as described herein, facilitates and/or enables such recall, access, and/or use of the treatment data by the clinician 104 in treating the patient 106.

In the treatment system 102, treatment logic 128 may be used to store, organize, access, recall, or otherwise use the information stored in the treatment data 126. For example, the treatment logic 128 may access a database management system (DBMS) engine 130, which may be operable to perform computing operations to insert or modify new data into/within the treatment data 126, perhaps in response to new research or findings, or in response to a preference of the clinician 104. For example, if a new treatment agent is discovered to be effective on the diseased tissue 114, the clinician 104 may access the treatment system 102 using a user interface 132, in order to use the DBMS engine 130 to associate the new treatment agent with one or more instances of the target-related tissue ancestry-correlated binding site(s) and/or target related tissue ancestry-correlated binding agent(s) that may be known to be useful in targeting the diseased tissue 114, within the treatment data database 126 (assuming that the treatment agent is suitable for direct or indirect delivery via the target-related tissue ancestry-correlated binding agent, as described herein). As another example, if a new target-related tissue ancestry-correlated binding site is identified in the endothelium layer 118 in the vicinity of the diseased tissue 114, then this new target-related tissue ancestry-correlated binding site may be associated with one or more instances of a target-related tissue ancestry-correlated binding agent, e.g., there may be more than one agent that is useful in attaching to the new target-related tissue ancestry-correlated binding site for delivery of one or more treatment agents.

Similarly, in a case where the clinician 104 seeks, for example, to diagnose or treat the patient 106, the clinician 104 may access the user interface 132 to use the treatment logic and/or DBMS Engine 130 to determine best known methods or treatments to be applied in a given clinical scenario. For example, if the patient 106 has a certain type of disease or illness in a certain region of the body, then the clinician may input this information via the user interface 132 in order to obtain one or more options for treating the disease or illness. For example, if the patient 106 exhibits the diseased tissue 114, then the clinician 104 may select the (type of) diseased tissue 114 in the lung 108 as an end target, and the treatment logic 128 may then interface with the DBMS engine 130 to obtain, from the treatment data 126, one or more options for providing the treatment agent to the diseased tissue 114, e.g., one or more target-related tissue ancestry-correlated binding sites (such as, for example, two different proteins that are expressed or displayed in the endothelium layer 118 in the vicinity of the diseased tissue 114). As another example, if the clinician 104 is already aware of a target-related tissue ancestry-correlated binding site in the vicinity of the diseased tissue 114, then the clinician 104 may input this information into the treatment system 102 and be provided with one or more, for example, target-related tissue ancestry-correlated binding agents that may be known to attach to the known target-related tissue ancestry-correlated binding site.

In this regard, it should be understood that multiple instances of a target-related tissue ancestry-correlated binding site, as described, may be present at any one location in the body, and, moreover, virtually any region or site in the body having a blood-tissue interface may also exhibit an associated, target-related tissue ancestry-correlated binding site. Further, new instances of target-related tissue ancestry-correlated binding sites may be discovered and/or approved for clinical use on a relatively frequent basis. Still further, there may be many different treatment parameters and/or characteristics that may be related to the various target-related tissue ancestry-correlated binding site(s) and/or target-related tissue ancestry-correlated binding agent(s), such as, for example, treatment agents and/or delivery mechanisms.

As a result, the clinician 104, e.g., a doctor in the field, may not be aware of all currently available content of the treatment data 126. Thus, the treatment system 102 provides the clinician with fast, accurate, current, and/or comprehensive treatment information, and also provides techniques to ensure that the treatment information remains accurate, current, and/or comprehensive, by allowing the addition and/or modification of the existing treatment data 126, as new treatment information becomes available.

In FIG. 1, the treatment system 102 is illustrated as possibly being included within a device 134. The device 134 may include, for example, a mobile computing device, such as a personal digital assistant (PDA), or a laptop computer. Of course, virtually any other computing device may be used to implement the treatment system 102, such as, for example, a workstation, a desktop computer, or a tablet PC.

Additionally, not all of the treatment system 102 need be implemented on a single computing device. For example, the treatment data 126 may be stored on a remote computer, while the user interface 132 and/or treatment logic 128 are implemented on a local computer. Further, aspects of the treatment system 102 may be implemented in different combinations and implementations than that shown in FIG. 1. For example, functionality of the DBMS engine 130 may be incorporated into the treatment logic 128 and/or the treatment data 126.

The treatment data 126 may be stored in virtually any type of memory that is able to store and/or provide access to information in, for example, a one-to-many, many-to-one, and/or many-to-many relationship. Such a memory may include, for example, a relational database and/or an object-oriented database, examples of which are provided in more detail herein.

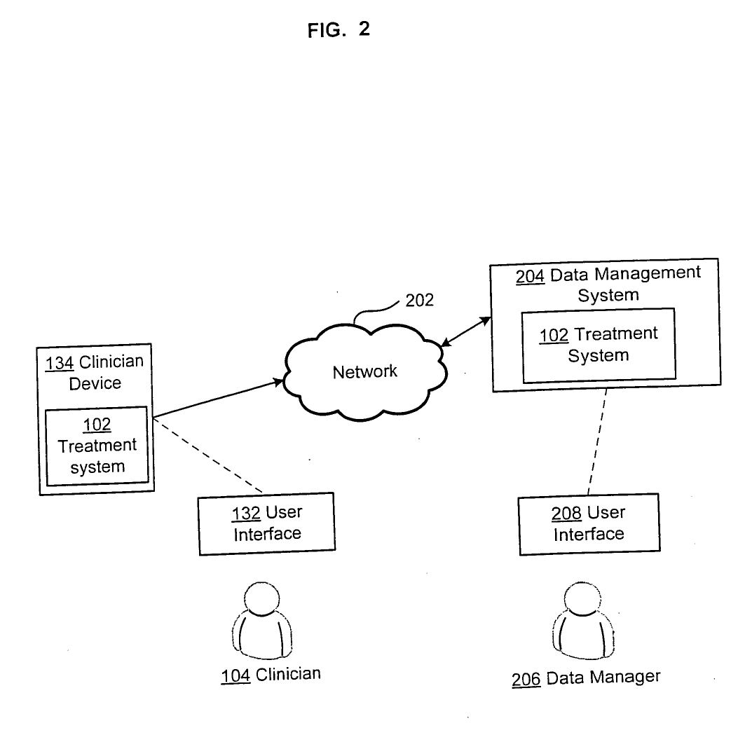

FIG. 2 illustrates certain alternative embodiments of the clinical system 100 of FIG. 1. In FIG. 2, the clinician 104 uses the user interface 132 to interact with the treatment system 102 deployed on the clinician device 134. The clinician device 134 is in communication over a network 202 with a data management system 204, which is also running the treatment system 102; the data management system 204 may be interacted with by a data manager 206 through a user interface 208. Of course, it should be understood that there may be many clinicians other then the specifically-illustrated clinician 104, each with access to an individual implementation of the treatment system 102. Similarly, multiple data management systems 204 may be implemented.

In this way, the clinician 104, who may be operating in the field, e.g., in an office and/or hospital environment, may be relieved of a responsibility to update or manage contents in the treatment data 126, or other aspects of the treatment system 102. For example, the data management system 204 may be a centralized system that manages a central database of the treatment data 126, and/or that deploys or supplies updated information from such a central database to the clinician device 134.

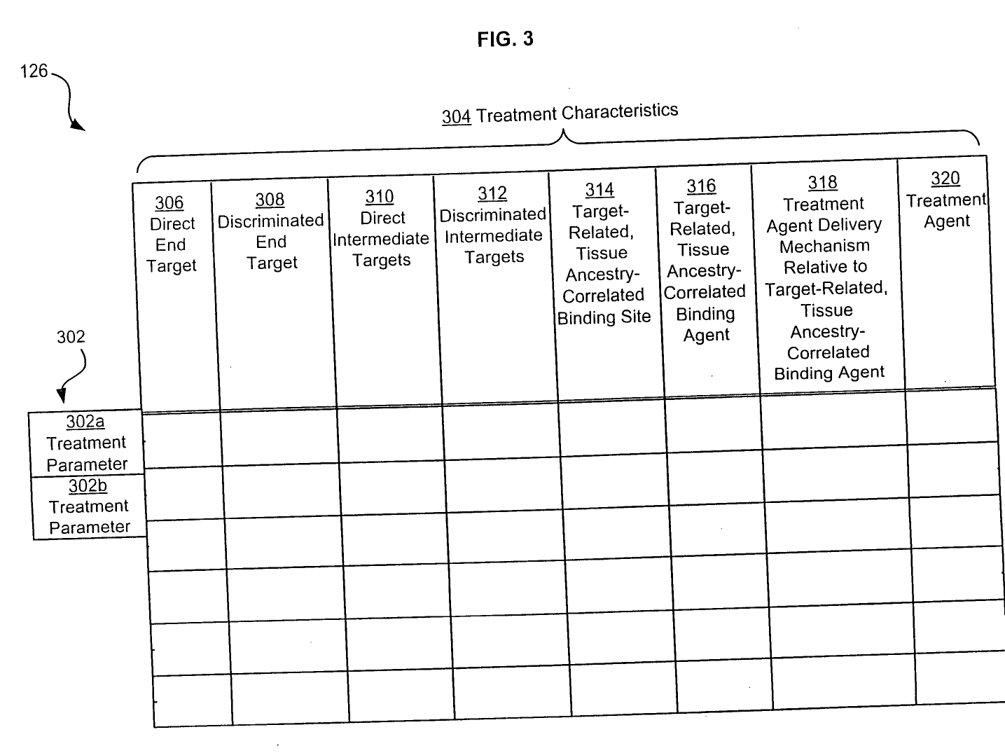

FIG. 3 illustrates an alternative embodiment of the treatment data 126 associated with the clinical system 100 of FIG. 1. In FIG. 3, and in the various examples herein, a particular nomenclature is used for the terms described above and related terms, in order to provide consistency and clarity of description. However, it should be understood that other terminology may be used to refer to the same or similar concepts.

In FIG. 3, treatment parameters 302 are stored and organized with respect to a plurality of treatment characteristics 304. The treatment characteristics 304 include many of the terms and concepts just described, as well as additional, but not exhaustive, terms and concepts that may be relevant to a use and operation of the treatment system 102.

For example, the treatment characteristics 304 include a direct end target 306. The direct end target 306 may refer, for example, to any tissue, organ, organ system, organ subsystem (or type thereof), or any other body part or region that may be targeted for healing, destruction, repair, enhancement, and/or imaging that may be targeted—directly or indirectly—via an associated target-related tissue ancestry-correlated binding site 314 and/or an associated tissue related tissue ancestry-correlated binding agent 316 and/or an associated treatment agent delivery mechanism relative to the target-related tissue ancestry-correlated binding agent 318 and/or an associated treatment agent 320. A discriminated end target 308 refers to targets that should be avoided during implementation of the healing, destruction, repair, enhancement and/or imaging actions that may be discriminated—directly or indirectly—via an associated target-related tissue ancestry-correlated binding site 314 and/or an associated tissue related tissue ancestry-correlated binding agent 316 and/or an associated treatment agent delivery mechanism relative to the target-related tissue ancestry-correlated binding agent 318 and/or an associated treatment agent 320. For example, in FIG. 1, the lung 108 may include the direct end target 306 as the diseased tissue 114, and may include the discriminated end target 308 as the healthy tissue 112, and/or the pancreas 110.

Somewhat analogously, a direct intermediate target 310 refers to targets that are connected to, associated with, or in the vicinity of the direct end target that may be targeted via an associated target-related tissue ancestry-correlated binding site 314 and/or an associated tissue related tissue ancestry-correlated binding agent 316 and/or an associated treatment agent delivery mechanism relative to the target-related tissue ancestry-correlated binding agent 318 and/or an associated treatment agent 320. For example, a portion of the endothelium layer 118 in a vicinity of the diseased tissue 114 (or other end target) may act as a direct intermediate target 310. Then, a discriminated intermediate target 312 may refer to endothelial tissue of the layer 118 that is not in a vicinity of the diseased tissue 114 that may be discriminated via an associated target-related tissue ancestry-correlated binding site 314 and/or an associated tissue related tissue ancestry-correlated binding agent 316 and/or an associated treatment agent delivery mechanism relative to the target-related tissue ancestry-correlated binding agent 318 and/or an associated treatment agent 320.

As already referenced, a target-related tissue ancestry-correlated binding site 314 refers to a determined chemical and/or genetic and/or biological structure to which various chemicals and/or genes may be affixed. For example, the target-related tissue ancestry-correlated binding site 314 may include a specific protein that is displayed at the endothelium layer 118 in a vicinity of the diseased tissue 114. The target-related tissue ancestry-correlated binding site 314 may be selectively associated with the direct end target 306 either directly or through the direct intermediate target 310.

A target-related tissue ancestry-correlated binding agent 316, then, may refer to some specific chemical and/or genetic and/or biological structure that more or less selectively binds or attaches to a related one of the target-related tissue ancestry-correlated binding sites 314. The target-related tissue ancestry-correlated binding agent 316 also may be associated with a treatment agent delivery mechanism relative to the target-related tissue ancestry-correlated binding agent 318, which may refer either to something that may be directly attached to (or associated with) the target-related tissue ancestry-correlated binding agent 316, and/or something that may be attached to (or associated with) one or more intermediary or indirect structures that attach to the target-related tissue ancestry-correlated binding agent 316 and that act to house and/or deliver a treatment agent 320. As an example of the intermediary or indirect structures just referenced, a nano-bottle may be used that dissolves in a vicinity of the target-related tissue ancestry-correlated binding site 314, and thereby delivers the treatment agent 320 included inside.

The treatment agent 320 thus binds/attaches to, or otherwise is associated with, either directly or indirectly, the target-related tissue ancestry-correlated binding agent 316. Thus, as described, the treatment agent 320 may be effectively transported to the appropriate direct intermediate target 310 and thereby to the target-related tissue ancestry-correlated binding site 314. In this way, the treatment agent 320 may be delivered to the direct end target 306 (or at least to a vicinity of the direct end target 306), while not being delivered either to the discriminated intermediate target(s) 312 and/or the discriminated end target(s) 308.

FIG. 3 thus illustrates that there may be many different relationships or associations between any one (or more) of the treatment characteristics 304. For example, one or more instances of any one or more of the treatment characteristics 304 may be considered to be one of the treatment parameters 302, and thereafter associated with one or more instances of the remaining treatment characteristics 304. For example, the direct end target 306 may be considered to be the treatment parameter(s) 302, where a first instance 302a of the direct end target 306 may refer to diseased lung tissue, and the second instance 302b may refer to diseased breast tissue, and both instances may be associated with an instance of the target-related tissue ancestry-correlated binding agent 316. Similarly, two or more instances of the target-related tissue ancestry-correlated binding agent 316 (e.g., I-labeled APP monoclonal antibodies generated for two different proteins) may be associated with one treatment agent 320 (e.g., radio-immunotherapy via low levels of radionuclides).

Many other examples of relationships and associations between the various treatment parameters 302 and/or the treatment characteristics 304 (and/or other treatment information) may be defined or determined and stored in the treatment data 126 according to the treatment logic 128. Certain of these examples are provided herein.

Additionally, although the treatment data 126 is illustrated conceptually in FIG. 3 as a flat table in which one or more of the selected treatment parameters 302 are associated with one or more of the treatment characteristics, it should be understood that this illustration is for explanation and example only, and is not intended to be limiting in any way with respect to the various ways in which the treatment data 126 may be stored, organized, accessed, recalled, or otherwise used.

For example, the treatment data 126 may be organized into one or more relational databases. In this case, for example, the treatment data 126 may be stored in one or more tables, and the tables may be joined and/or cross-referenced in order to allow efficient access to the information contained therein. Thus, the treatment parameter(s) 302 may define a record of the database(s) that is associated with various ones of the treatment characteristics 304.

In such cases, the various tables may be normalized so as, for example, to reduce or eliminate data anomalies. For example, the tables may be normalized to avoid update anomalies (in which the same information would need to be changed in multiple records, and which may be particularly problematic when treatment data database 126 is large), deletion anomalies (in which deletion of a desired field or datum necessarily but undesirably results in deletion of a related datum), and/or insertion anomalies (in which insertion of a row in a table creates an inconsistency with another row(s)). During normalization, an overall schema of the database may be analyzed to determine issues such as, for example, the various anomalies just referenced, and then the schema is decomposed into smaller, related schemas that do not have such anomalies or other faults. Such normalization processes may be dependent on, for example, desired schema(s) or relations between the treatment parameters 302 and/or treatment characteristics 304, and/or on desired uses of the treatment data 126.

Uniqueness of any one record in a relational database holding the treatment data 126 may be ensured by providing or selecting a column of each table that has a unique value within the relational database as a whole. Such unique values may be known as primary keys. These primary keys serve not only as the basis for ensuring uniqueness of each row (e.g., treatment parameter) in the database, but also as the basis for relating or associating the various tables within one another. In the latter regard, when a field in one of the relational tables matches a primary key in another relational table, then the field may be referred to a foreign key, and such a foreign key may be used to match, join, or otherwise associate (aspects of) the two or more related tables.

FIG. 3 and associated potential relational databases represent only one example of how the treatment data may be stored, organized, accessed, recalled, or otherwise used.

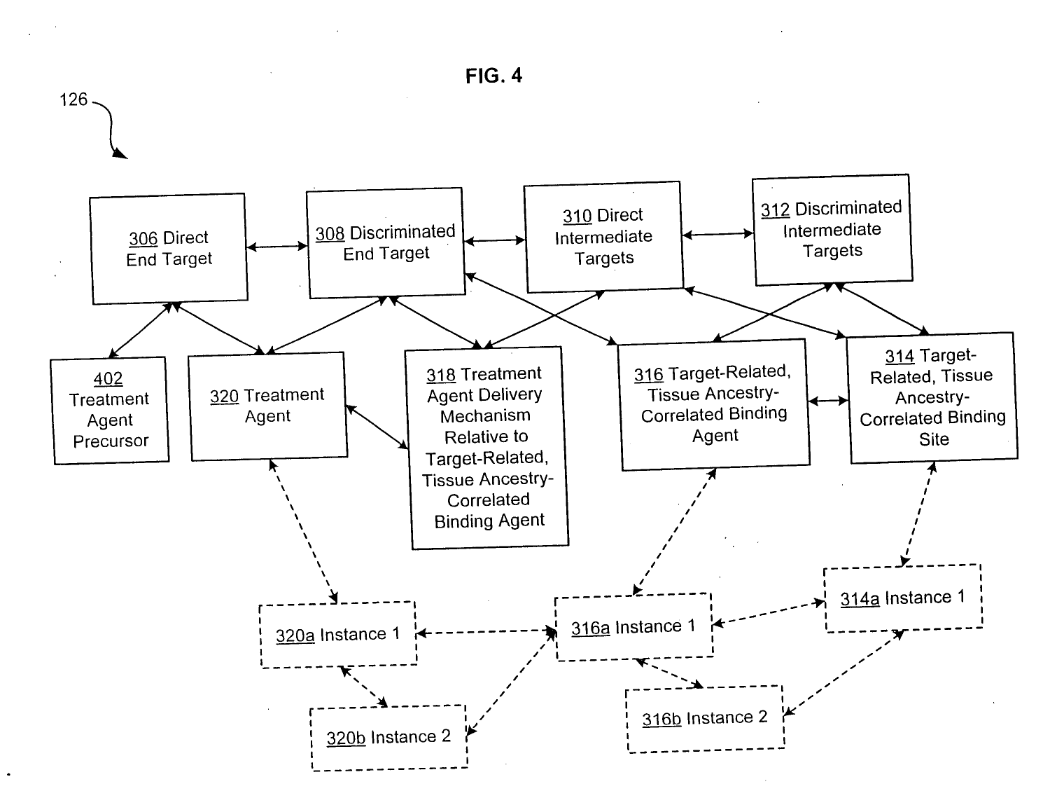

FIG. 4 illustrates another alternative embodiment of treatment data 126 associated with the clinical system 100 of FIG. 1, in which the treatment data 126 is conceptually illustrated as being stored in an object-oriented database.

In such an object-oriented database, the various treatment parameter(s) 302 and/or treatment characteristic(s) 304, and/or instances thereof, may be related to one another using, for example, links or pointers to one another. FIG. 4 illustrates a conceptualization of such a database structure in which the various types of treatment data are interconnected, and is not necessarily intended to represent an actual implementation of an organization of the treatment data 126.

The concepts described above may be implemented in the context of the object-oriented database of FIG. 4. For example, two instances 320a and 320b of the treatment agent 320 may be associated with one (or more) instance 316a of the target-related tissue ancestry-correlated binding agent 316. Meanwhile, two instances 316a and 316b of the target-related tissue ancestry-correlated binding agent 316 may be associated with an instance 314a of the target-related tissue ancestry-correlated binding site 314.

Also, other data may be included in the treatment data 126. For example, in FIG. 4, a treatment agent precursor 402 is shown that refers generally to an agent used to facilitate application of the treatment agent 320, e.g., an immune-response element that is used to identify/mark/bond with the target-related tissue ancestry-correlated binding site 314 and/or a substance that when metabolized becomes treatment agent 320, such as with prodrugs.

Many other examples of databases and database structures also may be used. Other such examples include hierarchical models (in which data is organized in a tree and/or parent-child node structure), network models (based on set theory, and in which multi-parent structures per child node are supported), or object/relational models (combining the relational model with the object-oriented model).

Such databases, and/or other memory storage techniques, may be written and/or implemented using various programming or coding languages. For example, object-oriented database management systems may be written in programming languages such as, for example, C++ or Java. Relational and/or object/relational models may make use of database languages, such as, for example, the structured query language (SQL), which may be used, for example, for interactive queries for information and/or for gathering and/or compiling data from the relational database(s).

As referenced herein, the treatment system 102 may be used to perform various data querying and/or recall techniques with respect to the treatment data 126, in order to facilitate treatment and/or diagnosis of the patient 106. For example, where the treatment data is organized, keyed to, and/or otherwise accessible using one or more of the treatment parameters 302 and/or treatment characteristics 304, various Boolean, statistical, and/or semi-boolean searching techniques may be performed.

For example, SQL or SQL-like operations over one or more of the treatment parameters 302/treatment characteristics 304 may be performed, or Boolean operations using the treatment parameters 302/treatment characteristics 304 may be performed. For example, weighted Boolean operations may be performed in which different weights or priorities are assigned to one or more of the treatment parameters 302/treatment characteristics 304, perhaps relative to one another. For example, a number-weighted, exclusive-OR operation may be performed to request specific weightings of desired (or undesired) treatment data to be included (excluded).

For example, the clinician 104 may wish to determine examples of the direct end target 306 that are associated with examples of the discriminated end target 308 that are highly discriminated against with respect to delivery of the target-related tissue ancestry-correlated binding agent 316, for highly-specific delivery of the treatment agent 320. For example, the clinician 104 may want to know instances of the treatment agent 320 that may be delivered to the lungs as the direct end target 306, without substantially affecting the pancreas, liver, or other tissue, organ, or organ system/subsystem. In other examples, the clinician may be willing to tolerate lower levels of discrimination (i.e., increased delivery of the treatment agent 320 to other body regions), perhaps because the patient 106 is in an advanced stage of illness. As another example, the clinician 104 may start with a preferred (type of) the treatment agent 320, and may request from the treatment system 102 various delivery techniques (e.g., target-related tissue ancestry-correlated binding agent 316) that may be available, and with varying levels of efficacy.

The clinician 104 may specify such factors using, for example, the user interface 132. For example, the clinician 104 may be able to designate one or more of the treatment parameters 302/treatment characteristics 304, and assign a weight or importance thereto, using, for example, a provided ranking system. In this regard, and as referenced herein, it should be understood that the clinician 104 may wish to deliver a particular instance of the treatment agent 320, e.g., a particular radionuclide to be delivered to a tumor. However, such a treatment agent, if applied by conventional techniques, may be problematic or prohibited (e.g., where a current strength of the patient 106 and/or an immune system of the patient 106 is insufficient to allow the clinician 104 to use the desired treatment agent). Moreover, the clinician 104 may not be aware that a suitable target-related tissue ancestry-correlated binding site 314 and/or target-related tissue ancestry-correlated binding agent 316 has (have) been discovered for delivering the treatment agent with a desired/required level of accuracy. However, the clinician 104 may query the treatment system 102 based on the desired treatment agent 320, and may thereby discover the technique(s) by which the treatment agent may be applied, and with the necessary level of specificity.

Similarly, data analysis techniques (e.g., data searching) may be performed using the treatment data 126, perhaps over a large number of databases. For example, the clinician 104 may perform a physical screening of the patient 106, and may input some body system, tissue, organ, or organ system/subsystem against which screening is to be performed. Then, the clinician should receive a listing of target-related tissue ancestry-correlated binding sites and/or target-related tissue ancestry-correlated binding agents that are ranked according to some criteria. For example, the clinician 104 may receive a listing of instances of the target-related tissue ancestry-correlated binding site 314 that provide a particularly high or low level of discrimination with respect to a particular direct end target 306, discriminated end target 308, and/or treatment agent 320. In this way, for example, if the patient 106 has an organ or organ subsystem that requires protection from a given instance of the treatment agent 320, then the clinician 104 may select an instance of the target-related tissue ancestry-correlated binding site 314 and/or of the target-related tissue ancestry-correlated binding agent 316 accordingly, even if some relative sacrifice of binding strength/accuracy is associated with such a selection.

By way of further example, other parameters/characteristics may be factored in. For example, elimination pathways may be tracked, databased, and/or weighted for use in the treatment data 126 and/or the treatment system 102. For example, if a particular instance of the target-related tissue ancestry-correlated binding agent is easily eliminated by the liver, then, in a case where the patient 106 has a weak liver, such an instance may be selected for delivering the treatment agent 320, even if an otherwise superior instance of the target-related tissue ancestry-correlated binding agent 316 is known. Algorithms implementing such query/recall/access/searching techniques may thus use Boolean or other techniques to output, for example, a thresholded, rank-ordered list. The treatment logic 128 may then assign a key or other identifier to such a list(s), for easier use thereof the next time a like query is performed.

Design and testing of querying techniques in particular implementations of the treatment system 102 may involve, for example, entry of candidate treatment parameters 302/treatment characteristics 304 (or instances thereof) into a database(s), along with associated test results and/or affinity metrics that may be used to determine/weight targets or sets of targets. Then, an identifier may be generated that is unique to the target(s) set(s).

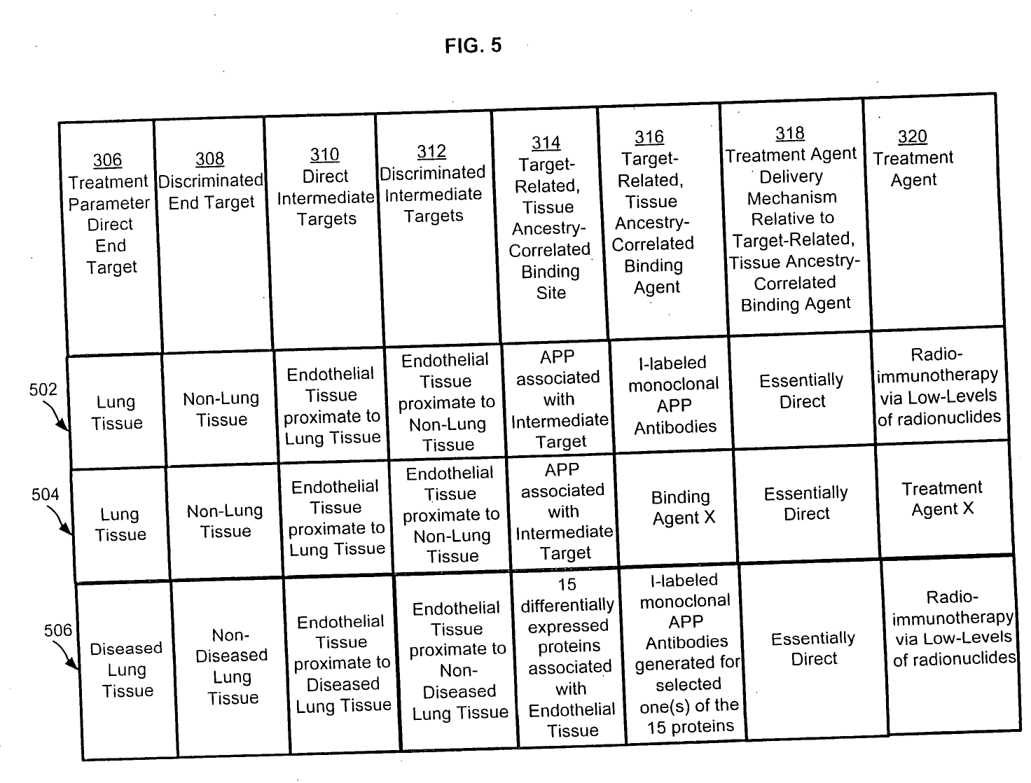

Still other examples/applications include avoiding an auto-immune response of the patient 106, in order to achieve a desired result. For example, the treatment system 102 may be used to determine/catalog/use treatment data that relates to treatment parameters 302/treatment characteristics 304 that are known or suspected to avoid self-epitopes (i.e., those unlikely to generate an undesired autoimmune response). FIG. 5 illustrates another alternative embodiment of treatment data associated with the clinical system 100 of FIG. 1, with specific examples of treatment data. In particular, all of FIGS. 5-7 provide or refer to example results from related technical papers, which are specifically referenced below.

For example, the first and second rows of the table of FIG. 5 (i.e., rows 502, 504, and 506, respectively) refer to examples that may be found in Oh, P. et al., “Subtractive Proteomic Mapping of the Endothelial Surface in Lung and Solid Tumours for Tissue-Specific Therapy,” Nature, vol. 429, pp. 629-635 (Jun. 10, 2004), which is hereby incorporated by reference in its entirety, and which may be referred to herein as the Oh reference.

In the Oh reference, it is generally disclosed that regions of endothelium may change or alter over time, based on what tissues are in the vicinity thereof, as referenced herein. The Oh reference, for example, identified lung-induced and/or lung-specific endothelial cell surface proteins based on a hypothesis that a surrounding tissue (micro) environment of the endothelial cell surface proteins modulates protein expression in the vascular endothelium. The Oh reference identified specific proteins that were found to be expressed at an endothelial surface by specifying two regions of interest (e.g., a “lung region” and a “non-lung region”), and then determining proteins within the two regions. Then, by subtracting the two sets of proteins from one another, non-common proteins were identified.

In this way, uniquely occurring proteins at a specific endothelial site (e.g., the target-related tissue ancestry-correlated binding site 314 at a specific direct intermediate target 31 0) were identified. Then, these uniquely-occurring proteins were used as targets for generated antibodies. As a result, it was possible to target, for example, lung-specific tissues as opposed to non-lung-specific tissues, and/or to target tumors as opposed to non-tumor tissues. More specifically, for example, it was determined to be possible to target tumor-induced endothelial cell proteins (i.e., target-related tissue ancestry-correlated binding sites 314) for delivery thereto of drugs, imaging agents, and/or radiation agents (i.e., treatment agents 320) that were attached to appropriate antibodies (target-related tissue ancestry-correlated binding agents 316).

Thus, to set forth specific examples, a row 502 illustrates an example in which the direct end target 306 includes a treatment parameter of “lung tissue.” In this example, the discriminated end target 308 includes “non-lung tissue.” The direct intermediate target 310 includes endothelial tissues that are proximate to the lung tissue, while the discriminated intermediate target 312 includes endothelial tissue that is proximate to the non-lung tissue.

The target-related tissue ancestry-correlated binding site 314 in this example includes aminopeptidase-P (APP), which is a protein that was detected substantially only in endothelial plasma membranes from the lung tissue (e.g., direct end target 306). In order to take advantage of the immuno-accessibility of APP in vivo, I-labeled monoclonal antibodies were used as the target-related tissue ancestry-correlated binding agent 316, and were intravenously injected into test rats. Subsequent imaging of the lungs illustrated rapid and specific targeting of APP antibody to the lung (i.e., direct end target 306), with significantly reduced accumulation of the injected dose at non-lung tissue (i.e., the discriminated end target 308). Thus, by selecting the treatment agent 320 to include radio-immunotherapy via low levels of radionuclides (e.g., 100 μ Ci), a treatment agent delivery mechanism relative to target-related tissue ancestry-correlated binding agent 318 may involve essentially direct delivery, in that the radionuclide (s) may be affixed to the I-labeled monoclonal APP antibodies.

In the row 504 of FIG. 5, a conceptual secondary example drawn from/based on the Oh reference is included, in order to illustrate various concepts described herein, e.g., with respect to FIGS. 1-4. Specifically, in the row 504, various ones of the treatment parameters and/or treatment characteristics are the same as in the row 502, except that a second example of the target-related tissue ancestry-correlated binding agent 316 is illustrated generically as “Binding Agent X,” and, similarly, a second example of a generically-referenced treatment agent 320 is illustrated as “Treatment Agent X.” As such, the row 504 illustrates, for example, that two separate instances of the target-related tissue ancestry-correlated binding agent 316 and/or the treatment agent 320 may be associated with, e.g., an instance of either the direct end target 306, and/or with an instance of the target-related tissue ancestry-correlated binding site 314.

The row 506 illustrates another example from the Oh reference. In the row 506, the direct end target 306 is illustrated as “diseased lung tissue,” while the discriminated end target 308 is illustrated as “non-diseased lung tissue.” Thus, the direct intermediate target 310 is illustrated as “endothelial tissue proximate to the diseased lung tissue,” while the discriminated intermediate target 312 is illustrated as “endothelial tissue that is proximate to non-diseased lung tissue.”

Then, the target-related tissue ancestry-correlated binding site 314 is illustrated as fifteen differentially-expressed proteins (e.g., expressed according to the subtractive techniques described herein) associated with the direct intermediate target 310, i.e., the endothelial tissue proximate to the diseased lung tissue. As a result, the target-related tissue ancestry-correlated binding agent 316 is selected and illustrated as I-labeled monoclonal APP antibodies that may be generated for one or more of the fifteen differentially-expressed proteins. As in the row 502, the treatment agent delivery mechanism relative to target-related tissue ancestry-correlated binding agent 318 may involve essentially direct attachment of the treatment agent 320 that is illustrated as radio-immunotherapy via low-levels of radionuclides. In this way, such radionuclides may be concentrated in, and may thereby destroy, tumors. In particular, for example, an identified tumor target was the 34 KDa protein recognized by annexin A1 (AnnA 1) antibodies only in tumor endothelial plasma membrane.

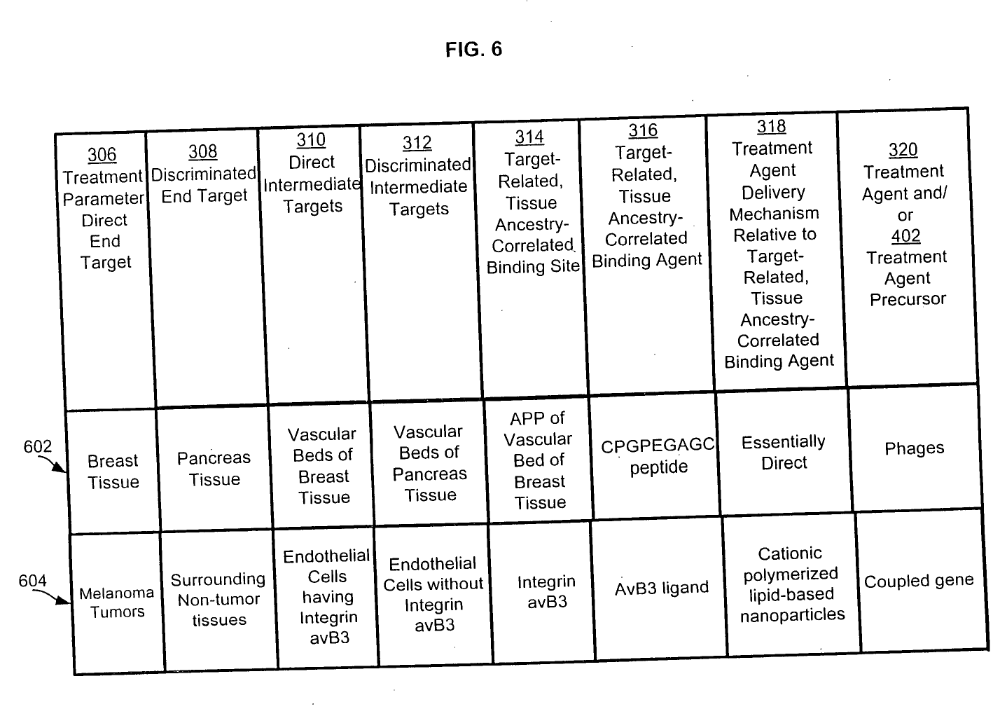

FIG. 6 illustrates additional alternative embodiments of treatment data associated with the clinical system I 00 of FIG. 1, with specific examples of treatment data. In FIG. 6, a row 602 illustrates examples that may be found in Essler et al., “Molecular Specialization of Breast Vasculature: A Breast-Homing Phage-Displayed Peptide Binds to Aminopeptidase P in Breast Vasculature,” Proceedings of the National Academy of Sciences, vol. 99, No. 4, pp. 2252-2257 (Feb. 19, 2002), which is hereby incorporated by reference in its entirety, and which may be referred to herein as the Essler reference.

In the Essler reference, a plurality of peptides (i.e., two or more amino acids joined together) having a general structure of CX7C (where C is cysteine and X is any amino acid) I-labeled monoclonal antibodies were injected into mice. Then tissues of interest were observed to determine a presence of phage(s), and thereby to determine which peptide of the plurality of peptides honed in on the observed tissue(s). In this way, it was determined that the CPGPEGAGC peptide was useful in providing a homing point for phages of the patient's immune system, and, in particular, was useful as a binding agent for the breast tissue, while not binding to pancreas tissue.

Thus, in the row 602, the direct end target 306 is illustrated as breast tissue, while the discriminated end target 308 is illustrated as pancreas tissue. The direct intermediate target 310 is illustrated as vascular beds of breast tissue, while the discriminated intermediate target 3 12 is illustrated vascular beds of pancreas tissue.

The target-related tissue ancestry-correlated binding site 3 14 includes a protein, aminopeptidase-P (APP), of the vascular bed of breast tissue. The target-related tissue ancestry-correlated binding agent 316 includes a cyclic nonapeptide known as the CPGPEGAGC peptide, which is shown in the Essler paper to home to the aminopeptidase P receptor. The treatment agent precursor 402 is shown to include phages, which were essentially directly delivered via the CPGPEGAGC peptide to the APP of the vascular bed of breast tissue, and which facilitate attachment of additional/alternative treatment agents 320 to the APP.

A row 604 of FIG. 6 illustrates an example from Hood et al., “Tumor Regression by Targeted Gene Delivery to the Neovasculature,” Science, vol. 296, pp. 2404-2407 (Jun. 28, 2002), which is incorporated by reference in its entirety and which is referred to herein as the Hood reference. The Hood reference refers to the molecule integrin avB3, that plays a role in endothelial cell survival during formation of new blood vessels in a given region, and is preferentially expressed therein. A cationic polymerized lipid-based nanoparticle was synthesized and covalently coupled to a small organic avB3 ligand; that is, the ligand was illustrated to serve as a binding agent for the integrin avB3 that is preferentially expressed in endothelial cells.

Accordingly, in the row 604, melanoma tumors were used as the direct end target 306, while the discriminated end target 308 is shown as surrounding non-tumor tissues. The direct intermediate target 310 is illustrated as endothelial cells having integrin avB3, while the discriminated intermediate target 312 is shown as endothelial cells without integrin avB3. Thus, the target-related tissue ancestry-correlated binding site 314 is shown to include the Integrin avB3, while the target-related tissue ancestry-correlated binding agent 316 is shown to include the avB3 ligand that attaches to the Integrin avB3. The treatment agent 320 included a gene selected to disrupt formation of new blood vessels in the tumor(s), which was delivered using the cationic polymerized lipid-based nanoparticle(s), and which thereby deprived the tumor(s) of blood and destroyed the tumor(s).

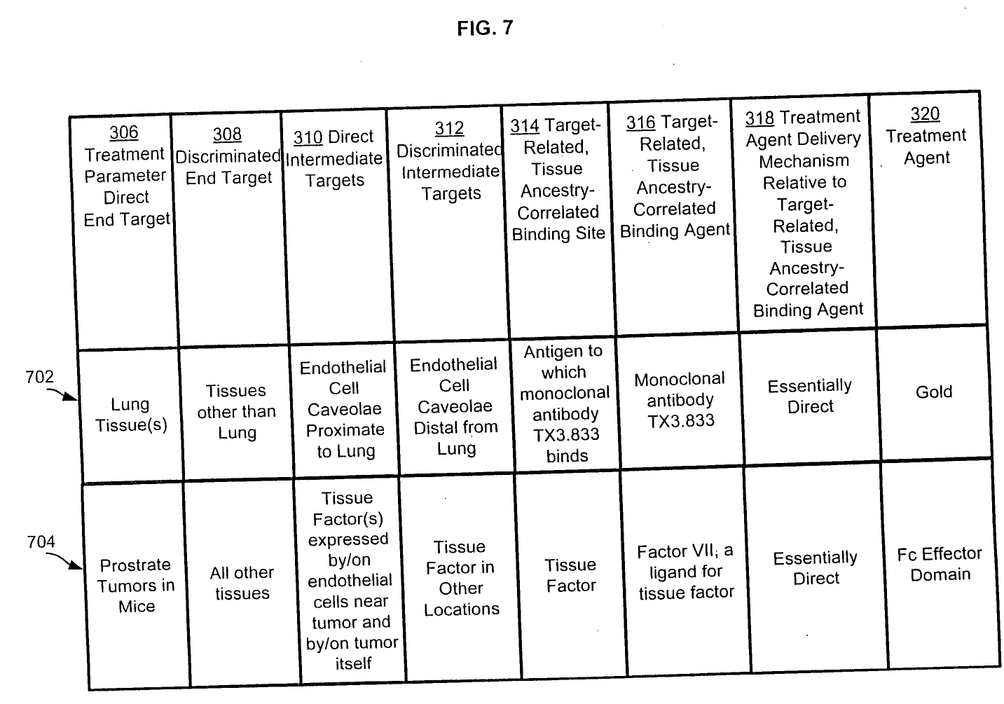

FIG. 7 illustrates additional embodiments of treatment data associated with the clinical system 100 of FIG. 1, with specific examples of treatment data. In a row 702, an example is illustrated from McIntosh et al., “Targeting Endothelium and Its Dynamic Caveolae for Tissue-Specific Transcytosis in vivo: A Pathway to Overcome Cell Barriers to Drug and Gene Delivery,” Proceedings of the National Academy of Sciences, vol. 99, no. 4, pp. 1996-2001 (Feb. 19, 2002), which is hereby incorporated by reference and which may be referred to herein as the McIntosh reference. In the McIntosh reference, endothelial cell plasma membranes from the lungs were analyzed to determine monoclonal antibodies targeted thereto. Additionally, the McIntosh illustrated use of the caveolae 124 to allow the treatment agent 320 to cross the endothelium and be delivered directly to lung tissue.

Thus, in the row 702, the direct end target 306 is shown as lung tissue, while the discriminated end target 308 is shown as non-lung tissue. The direct intermediate target 310 is shown as endothelial cell caveolae proximate to the lung tissue, while the discriminated intermediate target 312 is shown as endothelial cell caveolae that is distal from the lung tissue.

The target-related tissue ancestry-correlated binding site 314 is shown as a determined/selected antigen to which the monoclonal antibody TX3.833 binds, so that the target-related tissue ancestry-correlated binding agent 316 is shown as the monoclonal antibody TX3.833 itself. In this way, the treatment agent 320 of gold affixed directly to the TX3.833 antibody was crossed over the endothelial plasma membrane into the tissues of interest (e.g., lung tissues); in other words, the caveolae 124 was used to conduct transcytosis.

A row 704 illustrates an example from Zhiwei et al., “Targeting Tissue Factor on Tumor Vascular Endothelial Cells and Tumor Cells for Immunotherapy in Mouse Models of Prostatic Cancer,” Proceedings of the National Academy of Sciences, vol. 98, no. 21, pp. 12180-12185 (Oct. 9, 2001), which is hereby incorporated by reference in its entirety, and which may be referred to as the Zhiwei reference. In the Zhiwei reference, a “tissue factor” is identified as a transmembrane receptor that forms a strong and specific complex with an associated ligand, factor VII (fVIl). Such tissue factor, although not normally expressed on endothelial cells, may be expressed on tumor endothelial cells of the tumor vasculature.

Thus, in the example of the row 704, the direct end target 306 includes prostrate tumors, while the discriminated end target 308 includes all other tissues. The direct intermediate target 310 includes tissue factor(s) expressed by/on endothelial cells near the tumor(s) and by/on the tumor itself. The target-related tissue ancestry-correlated binding site 314 includes the tissue factor, while the target-related tissue ancestry-correlated binding site agent 316 includes the factor VII (fvII), the ligand for the tissue factor. In this way, the direct treatment agent 320 of an Fc effector domain was used to provide a marker for an induced immune response.

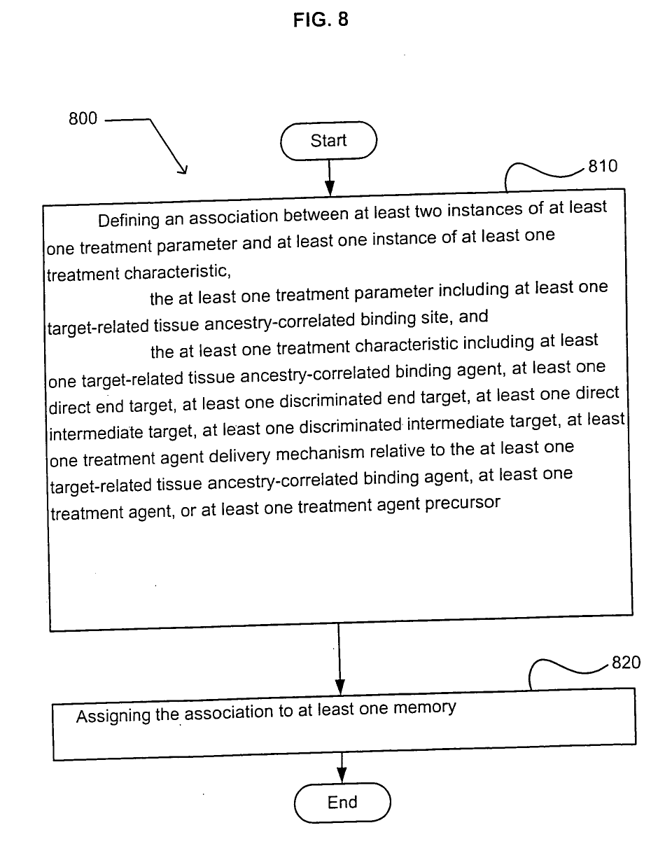

FIG. 8 illustrates an operational flow 800 representing example operations related to data techniques for tissue coding. In FIG. 8 and in following figures that include various examples of operational flows, discussion and explanation may be provided with respect to the above-described examples of FIGS. 1-7, and/or with respect to other examples and contexts. However, it should be understood that the operational flows may be executed in a number of other environment and contexts, and/or in modified versions of FIGS. 1-7. Also, although the various operational flows are presented in the sequence(s) illustrated, it should be understood that the various operations may be performed in other orders than those which are illustrated, or may be performed concurrently.

After a start operation, the operational flow 800 moves to a defining operation 810 where an association is defined between at least two instances of at least one treatment parameter and at least one instance of at least one treatment characteristic. The at least one treatment parameter includes at least one target-related tissue ancestry-correlated binding site, and the at least one treatment characteristic including at least one target-related tissue ancestry-correlated binding agent, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor.

For example, the treatment logic 128 of the treatment system 102 may receive a designation of at least two instances of the target-related tissue ancestry-correlated binding site 314, such as, for example, two or more of the fifteen differentially-expressed proteins referenced in the row 506 of FIG. 5. These two instances may then be associated within the treatment data 126 with one or more instances of, for example, the target-related tissue ancestry-correlated binding agent 316, such as, for example, an appropriate binding I-labeled monoclonal antibody. Of course, the two or more instances of the target-related tissue ancestry-correlated binding site 314 also may be associated with one or more instances of the treatment characteristics recited in the operation 810, such as, for example, one or more radionuclide(s) associated as an instance(s) of the treatment agent 320.

In an assigning operation 820, the association is then assigned to at least one memory. For example, the association may be assigned to one or more of the various (types of) databases referenced above, such as the relational and/or object-oriented database(s), or to another type of memory, not explicitly mentioned.

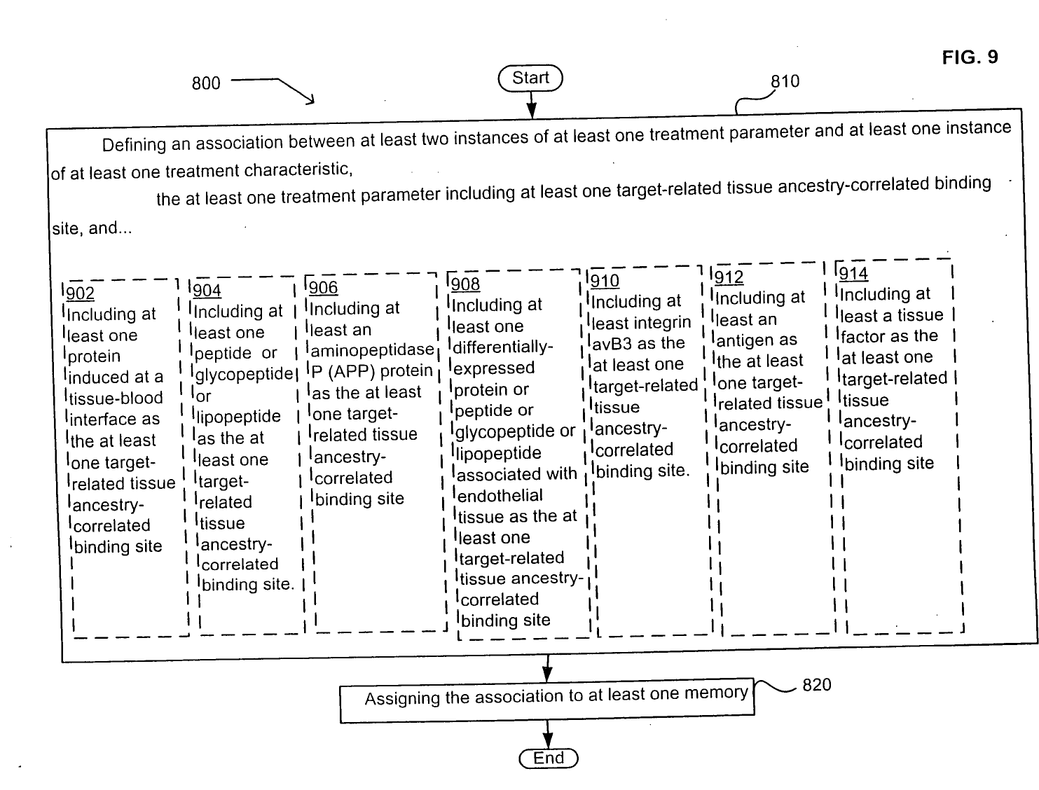

FIG. 9 illustrates alternative embodiments of the example operational flow 800 of FIG. 8. FIG. 9 illustrates example embodiments where the defining operation 8 1 0 may include at least one additional operation. Additional operations may include operation 902, operation 904, operation 906, operation 908, operation 910, operation 912, and/or operation 914.

At the operation 902, at least one protein induced at a tissue-blood interface may be included as the at least one target-related tissue ancestry-correlated binding site. For example, as referenced herein, the treatment data 126 may store a protein induced at an endothelium layer 118 to be used as the target-related tissue ancestry-correlated binding site.

At the operation 904, at least one peptide or glycopeptide or lipopeptide may be included as the at least one target-related tissue ancestry-correlated binding site. For example, the treatment data 126 may store a peptide as a selected in vivo target for antibodies in specified healthy and/or diseased tissues.

At the operation 906, at least an aminopeptidase P (APP) protein may be included as the at least one target-related tissue ancestry-correlated binding site. For example, as shown in rows 502 and/or 504 of FIG. 5, APP may be stored in the treatment data 126 as an instance of the target-related tissue ancestry-correlated binding site 314.

At the operation 908, at least one differentially-expressed protein or peptide or glycopeptide or lipopeptide associated with endothelial tissue may be included as the at least one target-related tissue ancestry-correlated binding site. For example, as shown in the row 506 of FIG. 5, such a differentially-expressed protein may be included as an instance of the target-related tissue ancestry-correlated binding site 314, for targeting thereof with an appropriate antibody and subsequent delivery of the associated/attached treatment agent 320 to diseased lung tissue as an instance of the direct end target 306.

At the operation 910, at least integrin avB3 may be included as the at least one target-related tissue ancestry-correlated binding site. For example, as shown in the row 604 of FIG. 6, the treatment data 126 may store integrin avB3 as a target for delivering a desired gene to melanoma tumor cells, without delivering the gene to surrounding, non-cancerous cells.

At the operation 912, at least an antigen may be included as the at least one target-related tissue ancestry-correlated binding site. For example, as shown in the row 702 of FIG. 7, the treatment data 126 may store an antigen to which the monoclonal antibody TX3.833 binds, in order to provide the clinician 104 with information that such an antigen may be used to direct the TX3.833 antibody thereto.

At the operation 914, at least a tissue factor may be included as the at least one target-related tissue ancestry-correlated binding site. For example, as shown in the row 704 of FIG. 7, the treatment data 126 may store a tissue factor having a known and associated ligand therefore (e.g., fvII).

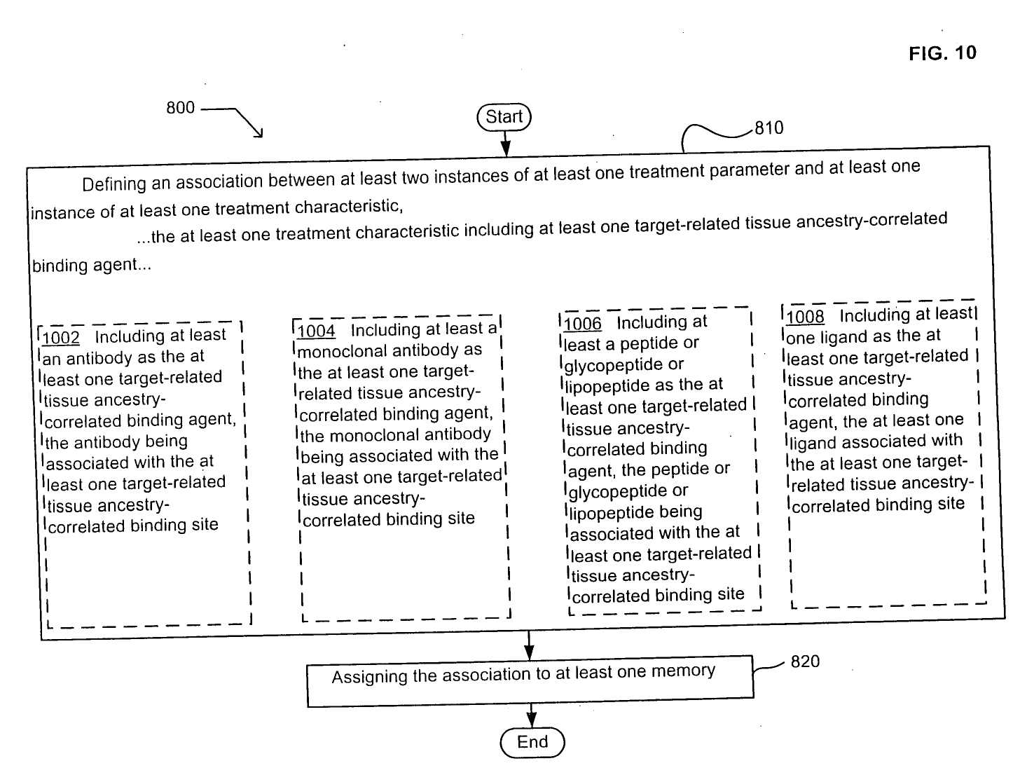

FIG. 10 illustrates alternative embodiments of the example operational flow 800 of FIG. 8. FIG. 10 illustrates example embodiments where the defining operation 810 may include at least one additional operation. Additional operations may include operation 1002, operation 1004, operation 1006, and/or operation 1008.

At the operation 1002, at least an antibody is included as the at least one target-related tissue ancestry-correlated binding agent, the antibody being associated with the at least one target-related tissue ancestry-correlated binding site. For example, as shown in rows 502, 504, and 506 of FIG. 5, and as shown in the row 702 of FIG. 7, various types of antibodies may be selected as instance(s) of the target-related tissue ancestry-correlated binding agent 316 for association with corresponding instances of the target-related tissue ancestry-correlated binding site 314 (e.g., APP and/or antigen), within the treatment data 126 of the treatment system 102.

At the operation 1004, at least a monoclonal antibody may be included as the at least one target-related tissue ancestry-correlated binding agent, the monoclonal antibody being associated with the at least one target-related tissue ancestry-correlated binding site. For example, as again shown in rows 502, 504, and 506 of FIG. 5, and as shown in the row 702 of FIG. 7, various types of I-labeled monoclonal antibodies may be appropriately selected as instance(s) of the target-related tissue ancestry-correlated binding agent 316 for association with corresponding instances of the target-related tissue ancestry-correlated binding site 314, within the treatment data 126 of the treatment system 102. In this way, the (monoclonal) antibodies may be used to target the corresponding target-related tissue ancestry-correlated binding site(s), for delivery of a desired instance of the treatment agent 320, as described herein.

At the operation 1006, at least a peptide or glycopeptide or lipopeptide may be included as the at least one target-related tissue ancestry-correlated binding agent, the peptide or glycopeptide or lipopeptide being associated with the at least one target-related tissue ancestry-correlated binding site. For example, as shown in the row 602 of FIG. 6, the treatment data 126 may store the CPGPEGAGC peptide as the target-related tissue ancestry-correlated binding agent 316, where the CPGPEGAGC is known to bind to a target-related tissue ancestry-correlated binding site such as APP, e.g., the APP of vascular bed(s) of breast tissue.

At the operation 1008, at least one ligand may be included as the at least one target-related tissue ancestry-correlated binding agent, the at least one ligand associated with the at least one target-related tissue ancestry-correlated binding site. For example, as shown in the row 704 of FIG. 7, the ligand fvII may be used as the target-related tissue ancestry-correlated binding agent 316 for the target-related tissue ancestry-correlated binding site 314 of tissue factor, an association that may be stored within the treatment data 126.

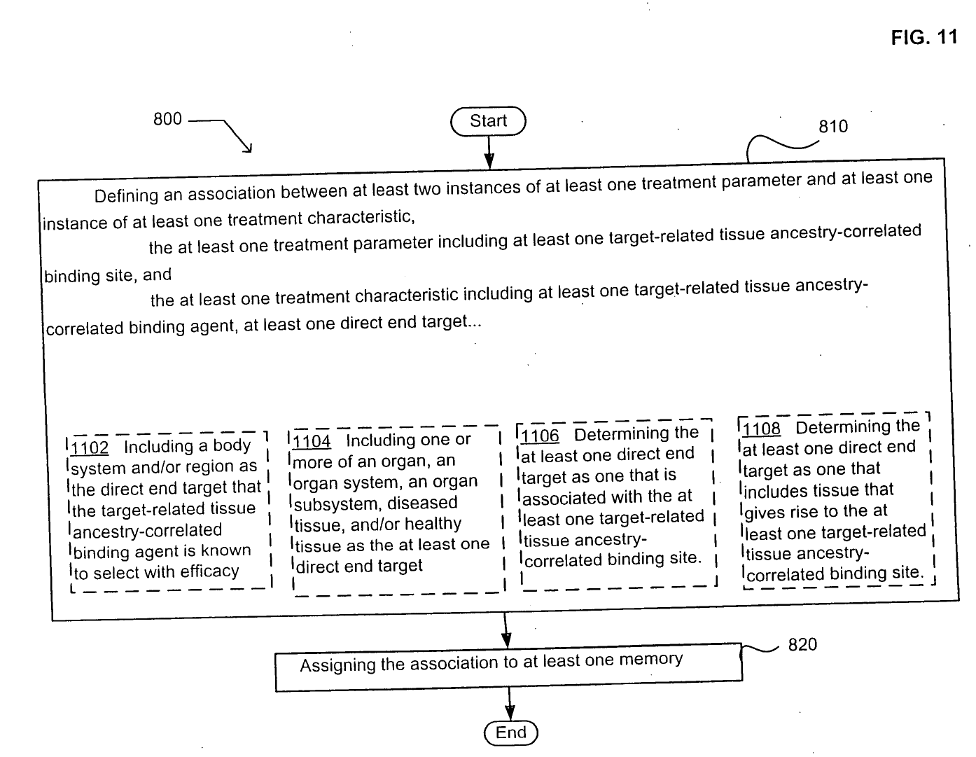

FIG. 11 illustrates alternative embodiments of the example operational flow 800 of FIG. 8. FIG. 11 illustrates example embodiments where the defining operation 810 may include at least one additional operation. Additional operations may include operation 1102, operation 1104, operation 1106, and/or operation 1108.

At the operation 1102, a body system and/or region may be selected as the direct end target that the target-related tissue ancestry-correlated binding agent is known to select with efficacy. For example, the treatment data 126 may store information about the cardiovascular system, the digestive system, the respiratory system, and/or regions associated therewith, or other body systems/regions, as the direct end target 306.

At the operation 1104, one or more of an organ, an organ system, an organ subsystem, diseased tissue, and/or healthy tissue may be included as the at least one direct end target. For example, the treatment data 126 may store information about the lungs, liver, pancreas, or other organ, or breast or other tissue, as the direct end target 306. Additionally, diseased tissue in these or other organs, e.g., tumors or other cancerous cells, or healthy tissues, e.g., adipose tissue, also may be included as the direct end target 306.

At the operation 1106, the at least one direct end target may be determined to be one that is associated with the at least one target-related tissue ancestry-correlated binding site. For example, the direct end target 306 in the treatment data 126 may, in an example instance, include lung tissue from the lung 108, which may be associated with APP (or other protein) associated with endothelial tissue 118 within the blood vessel 116.

At the operation 1108, the at least one direct end target may be determined to be one that includes tissue that gives rise to the at least one target-related tissue ancestry-correlated binding site. For example, as shown in the row 602 of FIG. 6, the direct end target 306 of (a vascular bed of) breast tissue may give rise to associated endothelial tissue within a blood vessel of the breast tissue, and on which APP or other protein may develop that is specific to the endothelial tissue.

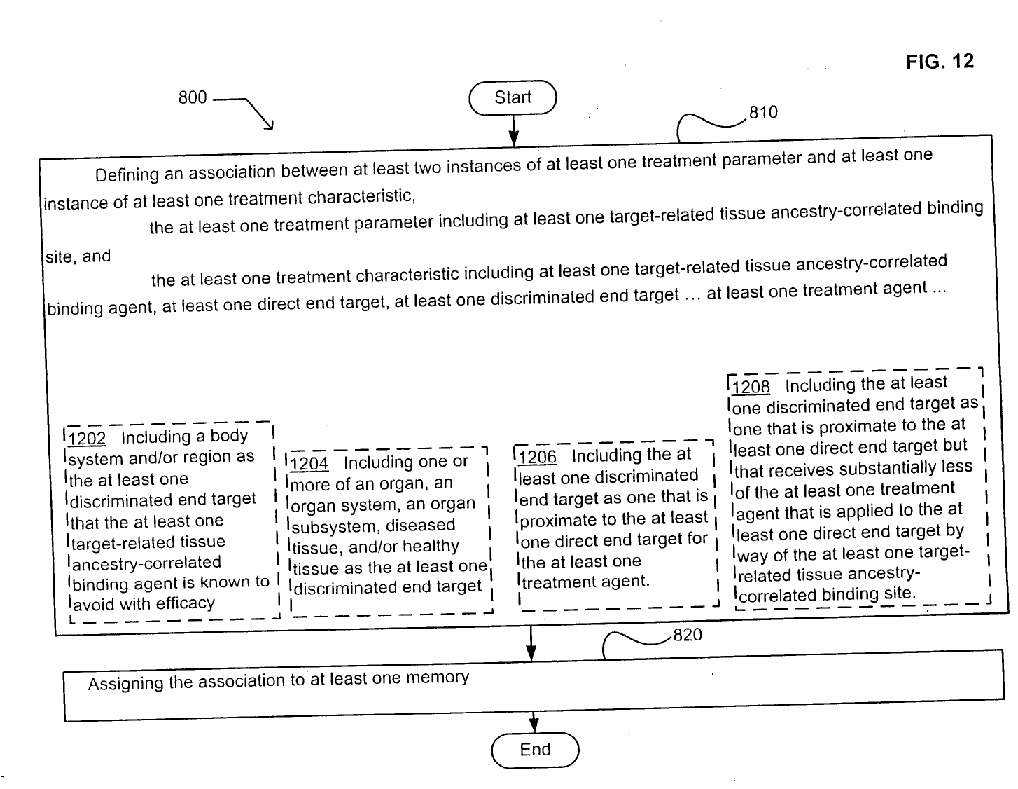

FIG. 12 illustrates alternative embodiments of the example operational flow 800 of FIG. 8. FIG. 12 illustrates example embodiments where the defining operation 810 may include at least one additional operation. Additional operations may include operation 1202, operation 1204, operation 1206, and/or operation 1208.

At the operation 1202, a body system and/or region may be included as the at least one discriminated end target that the at least one target-related tissue ancestry-correlated binding agent is known to avoid with efficacy. For example, where the direct end target 306 includes the diseased tissue 114 in FIG. 1, the discriminated end target 308 may include the healthy lung tissue 112, so that the treatment agent 320 (e.g., radionuclides) targets the diseased tissue 114, but exposes the healthy tissue 112 to a much lesser extent.

At the operation 1204, one or more of an organ, an organ system, an organ subsystem, diseased tissue, and/or healthy tissue may be included as the at least one discriminated end target. For example, the treatment data 126 may store information about the lungs, liver, pancreas, or other organ, or breast or other tissue, as the discriminated end target 308. Additionally, diseased tissue in these or other organs, e.g., tumors or other cancerous cells, or healthy tissues, e.g., adipose tissue, also may be included as the discriminated end target 308.

At the operation 1206, the at least one discriminated end target may be included as one that is proximate to the at least one direct end target for the at least one treatment agent. For example, the healthy tissue 112 may be proximate to the diseased tissue 114 within tissue of the lung 108.

At the operation 1208, the at least one discriminated end target may be included as one that is proximate to the at least one direct end target but that receives substantially less of the at least one treatment agent that is applied to the at least one direct end target by way of the at least one target-related tissue ancestry-correlated binding site. For example, in the row 604 of FIG. 6, in which the illustrated direct end target 306 includes melanoma tumors, the discriminated end target 308 includes (proximate) surrounding non-tumor tissues, and, as described herein, in the example of the row 604, the treatment agent 320 (e.g., the coupled gene) is applied to the melanoma tumors by way of the target-related tissue ancestry-correlated binding site 314 (e.g., Integrin AvB3), so that the surrounding non-tumor tissues receive substantially less of the treatment agent 320 (coupled gene) than do the melanoma tumors themselves.

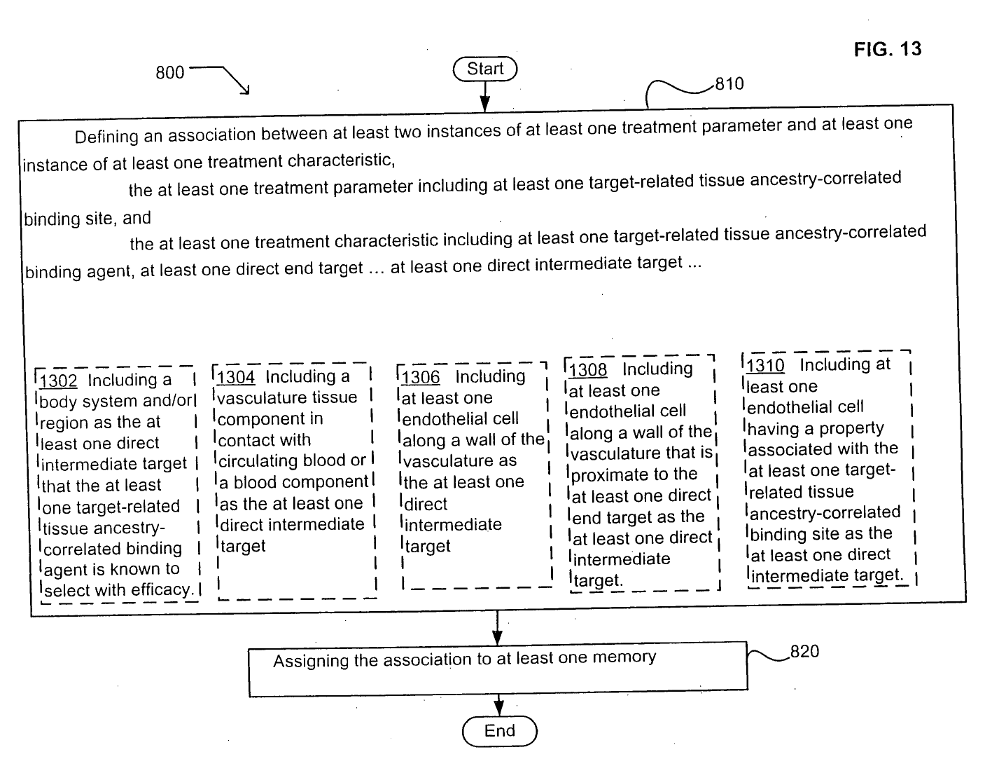

FIG. 13 illustrates alternative embodiments of the example operational flow 800 of FIG. 8. FIG. 13 illustrates example embodiments where the defining operation 810 may include at least one additional operation. Additional operations may include operation 1302, operation 1304, operation 1306, operation 1308, and/or operation 1310.

At the operation 1302, a body system and/or region may be included as the at least one direct intermediate target that the at least one target-related tissue ancestry-correlated binding agent is known to select with efficacy. For example, the treatment data 126 may store an identification of endothelial cells within the endothelium layer 118 which may be included as the direct intermediate target 308 that the target-related tissue ancestry-correlated binding agent 316 (e.g., I-labeled monoclonal APP antibodies) selects with efficacy.

At the operation 1304, a vasculature tissue component in contact with circulating blood or a blood component may be included as the at least one direct intermediate target. For example, the vasculature tissue component may include endothelial cells lining a blood vessel wall and in contact with the circulating blood, as described herein with respect to, for example, rows 502-506 of FIG. 5.

At the operation 1306, at least one endothelial cell along a wall of the vasculature may be included as the at least one direct intermediate target. For example, as illustrated in the row 604 of FIG. 6, endothelial cells having integrin AvB3 may be included as the direct intermediate target 308.

At the operation 1308, at least one endothelial cell along a wall of the vasculature that is proximate to the at least one direct end target as the at least one direct intermediate target. For example, and again as shown in the row 604 of FIG. 4, the endothelial cells having integrin AvB3 may be present along a blood vessel wall that is proximate to the melanoma tumors that may be used as the direct end target 306, and may thus be used as the direct intermediate target 308.

At the operation 1310, at least one endothelial cell having a property associated with the at least one target-related tissue ancestry-correlated binding site may be included as the at least one direct intermediate target. For example, an endothelial cell in the endothelium layer 118 may have a property (e.g., a displayed protein, such as APP) associated with the target-related tissue ancestry-correlated binding site 316.

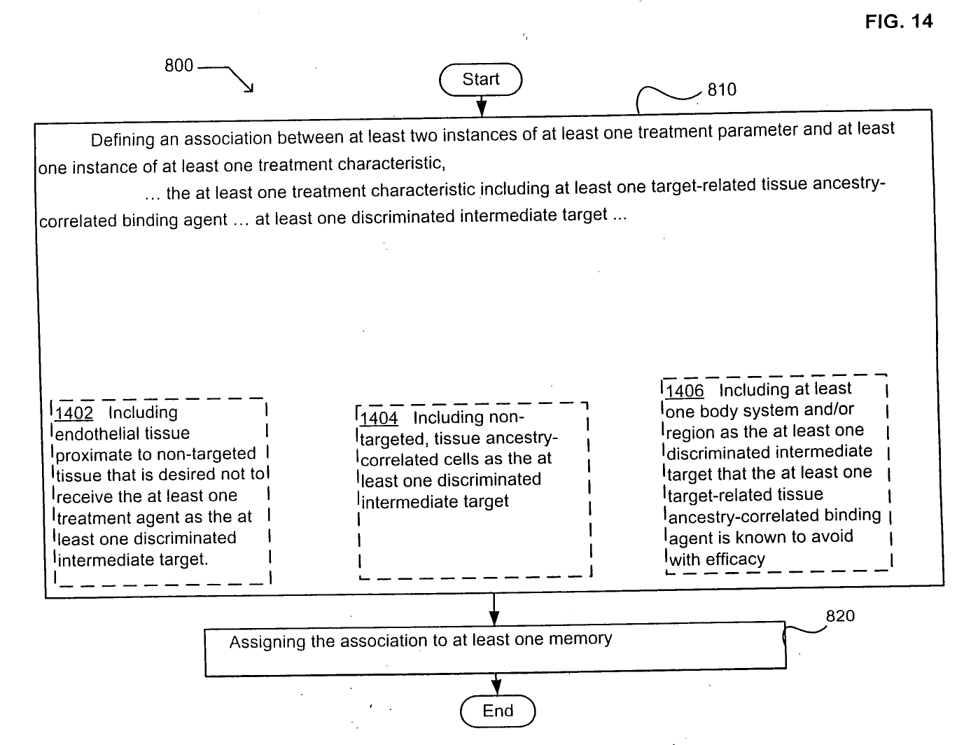

FIG. 14 illustrates alternative embodiments of the example operational flow 800 of FIG. 8. FIG. 14 illustrates example embodiments where the defining operation 810 may include at least one additional operation. Additional operations may include operation 1402, operation 1404, and/or operation 1406.

At the operation 1402, endothelial tissue proximate to non-targeted tissue that is desired not to receive the at least one treatment agent may be included as the at least one discriminated intermediate target. For example, tissue in the endothelial layer 122 that is proximate to (non-targeted) healthy tissue 112 that is desired not to receive the treatment agent 320 (e.g., radionuclides) may be included as the at least one discriminated intermediate target 312.

At the operation 1404, non-targeted, tissue ancestry-correlated cells may be included as the at least one discriminated intermediate target. For example, if non-targeted tissue(s) include non-lung tissues when targeted tissue(s) include lung tissues, as in the example of the rows 502 and 504 of FIG. 5, then endothelial cells proximate to the non-targeted, non-lung tissue(s) may be included as the at least one discriminated intermediate target 312.

At the operation 1406, at least one body system and/or region may be included as the at least one discriminated intermediate target that the at least one target-related tissue ancestry-correlated binding agent is known to avoid with efficacy. For example, in the row 602 of FIG. 6, the vascular beds of pancreas tissue may be included as the discriminated intermediate target 312 that the target-related tissue ancestry-correlated binding agent 316 (e.g., CPGPEGAGC peptide) is known to avoid with efficacy.

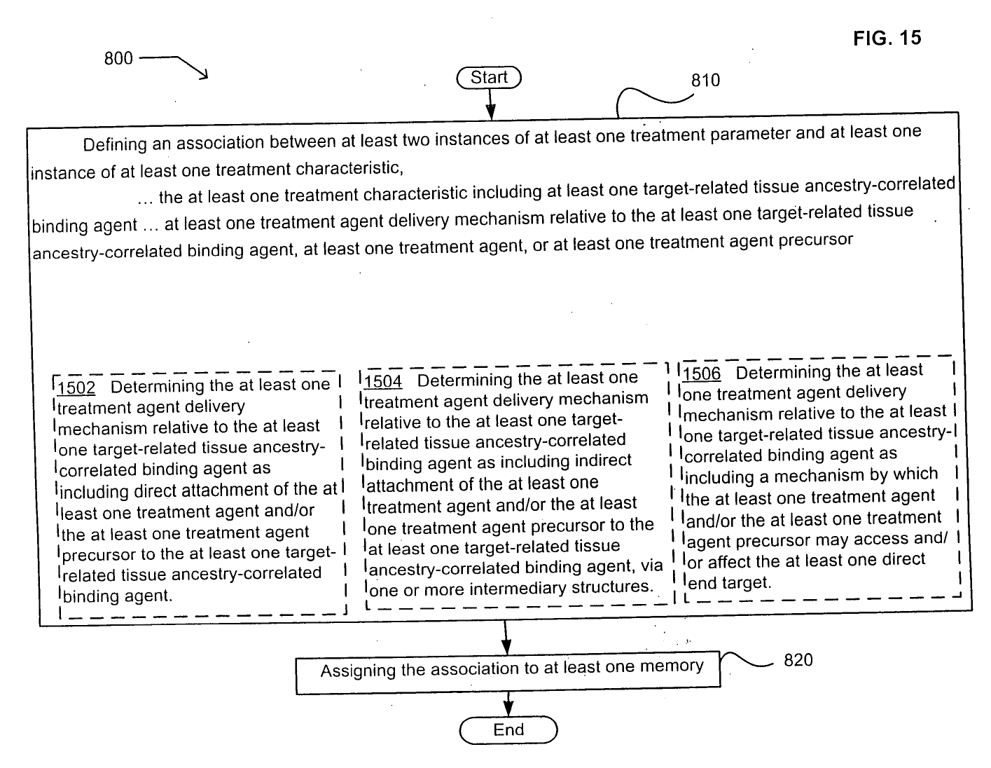

FIG. 15 illustrates alternative embodiments of the example operational flow 800 of FIG. 8. FIG. 15 illustrates example embodiments where the defining operation 810 may include at least one additional operation. Additional operations may include operation 1502, operation 1504, and/or operation 1506.

At the operation 1502, the at least one treatment agent delivery mechanism relative to the at least one target-related tissue ancestry-correlated binding agent may be determined as including direct attachment of the at least one treatment agent and/or the at least one treatment agent precursor to the at least one target-related tissue ancestry-correlated binding agent. For example, as in example of the rows 502, 504, and/or 506 of FIG. 5, the described target-related tissue ancestry-correlated binding agent(s) 316, e.g., I-labeled monoclonal antibodies generated for a protein(s) associated with the target-related tissue ancestry-correlated binding site(s) 314, may directly attach to the treatment agent 320, e.g., low levels of radionuclides.

At the operation 1504, the at least one treatment agent delivery mechanism relative to the at least one target-related tissue ancestry-correlated binding agent may be determined as including indirect attachment of the at least one treatment agent and/or the at least one treatment agent precursor to the at least one target-related tissue ancestry-correlated binding agent, via one or more intermediary structures. For example, as in the row 604 of FIG. 6, cationic polymerized lipid-based nanoparticles may be used to attach a coupled gene acting as the treatment agent 320 to an AvB3 ligand being used as the target-related tissue ancestry-correlated binding agent 316, for delivery of the coupled gene to the, in this example, vascular beds of breast tissue acting as the direct intermediate target 312.

At the operation 1506, the at least one treatment agent delivery mechanism relative to the at least one target-related tissue ancestry-correlated binding agent may be determined to include a mechanism by which the at least one treatment agent and/or the at least one treatment agent precursor may access and/or affect the at least one direct end target. For example, again referring to the row 604 of FIG. 6, the cationic polymerized lipid-based nanoparticles may be used to affect the direct end target 306, e.g., melanoma tumors.

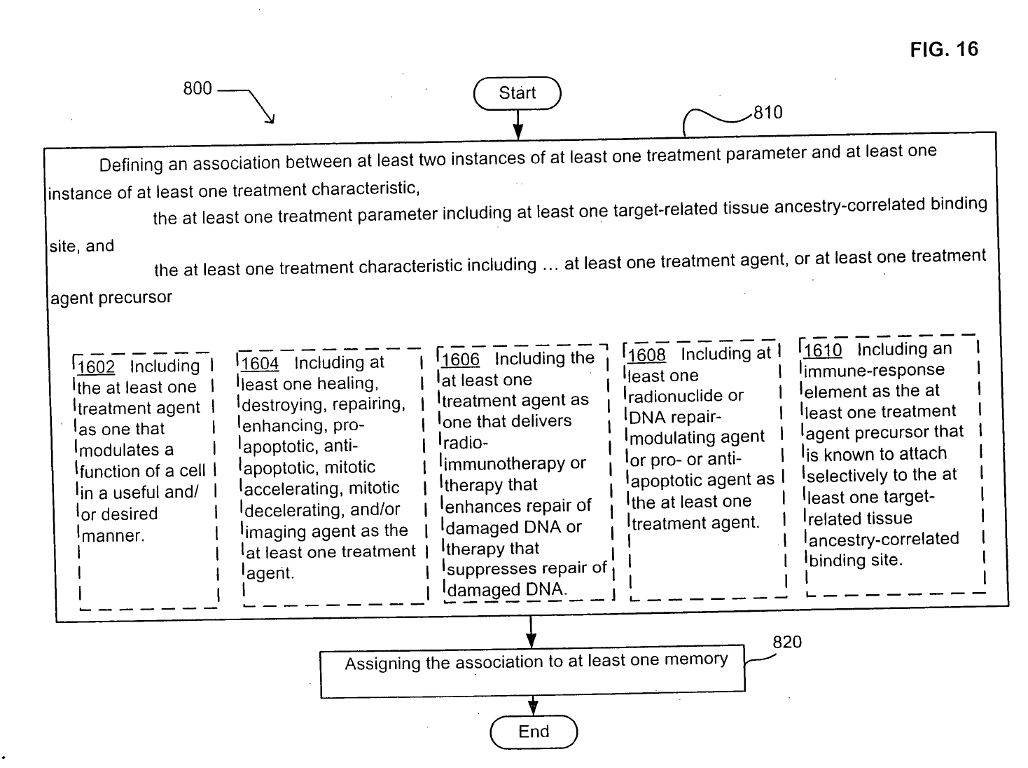

FIG. 16 illustrates alternative embodiments of the example operational flow 800 of FIG. 8. FIG. 16 illustrates example embodiments where the defining operation 810 may include at least one additional operation. Additional operations may include operation 1602, operation 1604, 1606, 1608, and/or operation 1610.

At the operation 1602, the at least one treatment agent may be included as one that modulates a function of a cell in a useful and/or desired manner. For example, the treatment agent 320 may include various chemical, biological, or genetic agents stored in the treatment data 126 for use by the treatment system 102.

At the operation 1604, at least one healing, destroying, repairing, enhancing, pro-apoptotic, anti-apoptotic, mitotic accelerating, mitotic decelerating, and/or imaging agent may be included as the at least one treatment agent. For example, in the row 604 of FIG. 6, a desired gene may be coupled to the target-related tissue ancestry-correlated binding agent 316 (e.g., through use of a nanoparticle(s), as described), for disrupting formation of new blood vessels in the described melanoma tumor(s),and for thereby depriving the tumor(s) of blood and inhibiting the tumor(s). As another example, an imaging agent may be used as the treatment agent 320 that targets a desired body portion or region that is to be imaged, and that thereby facilitates accurate and selective imaging of the body portion or region.

At the operation 1606, the at least one treatment agent may be included as one that delivers radio-immunotherapy or therapy that enhances repair of damaged DNA or therapy that suppresses repair of damaged DNA. For example, in the row 502 of FIG. 5, the treatment agent 320 stored in the treatment data 126 is illustrated as including radio-immunotherapy through low levels of radionuclides.

At the operation 1608, at least one radionuclide or DNA repair-modulating agent or pro- or anti-apoptotic agent may be included as the at least one treatment agent. For example, and similar to the example just mentioned, the row 506 illustrates use of a radionuclide as the treatment agent 320 used to attempt to destroy or reduce the direct end target 306 of diseased lung tissue.

At the operation 1610, an immune-response element may be included as the at least one treatment agent precursor that is known to attach selectively to the at least one target-related tissue ancestry-correlated binding site. For example, as in the row 602 of FIG. 6, phages may be used as the treatment agent precursor 402.

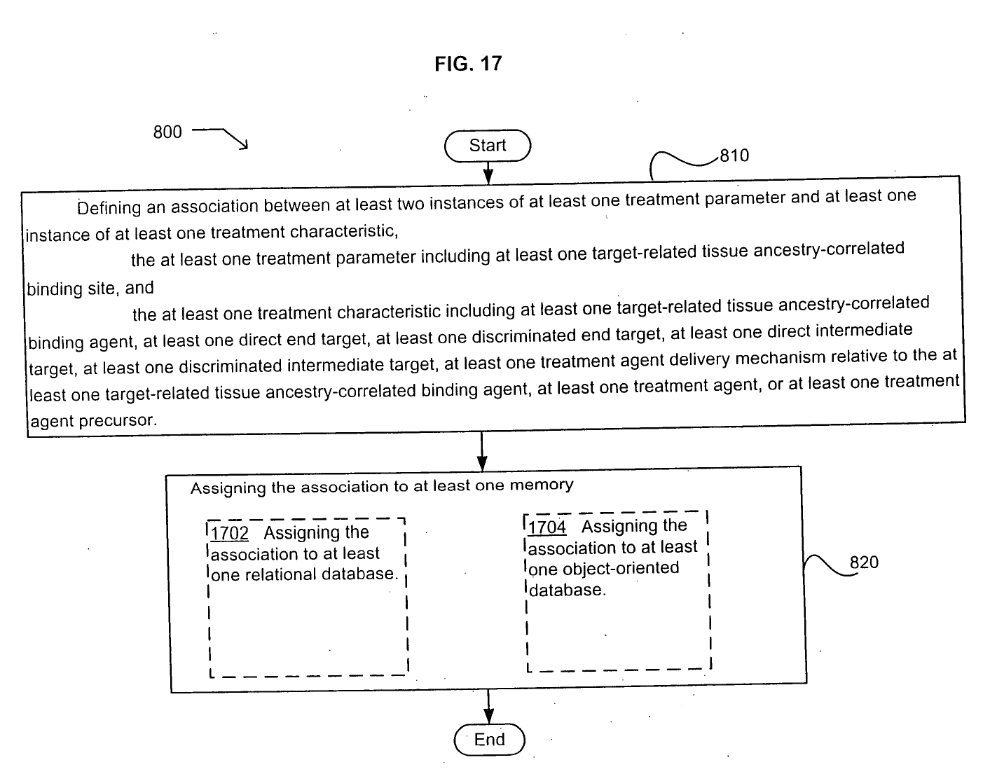

FIG. 17 illustrates alternative embodiments of the example operational flow 800 of FIG. 8. FIG. 17 illustrates example embodiments where the assigning operation 820 may include at least one additional operation. Additional operations may include operation 1702, and/or operation 1704.

At the operation 1702, the association of the operation 810 may be assigned to at least one relational database. For example, the treatment data 126 may be stored in one or more relational databases.

At the operation 1704, the association of the operation 810 may be assigned to at least one object-oriented database. For example, the treatment data 126 may be stored in one or more object-oriented databases.

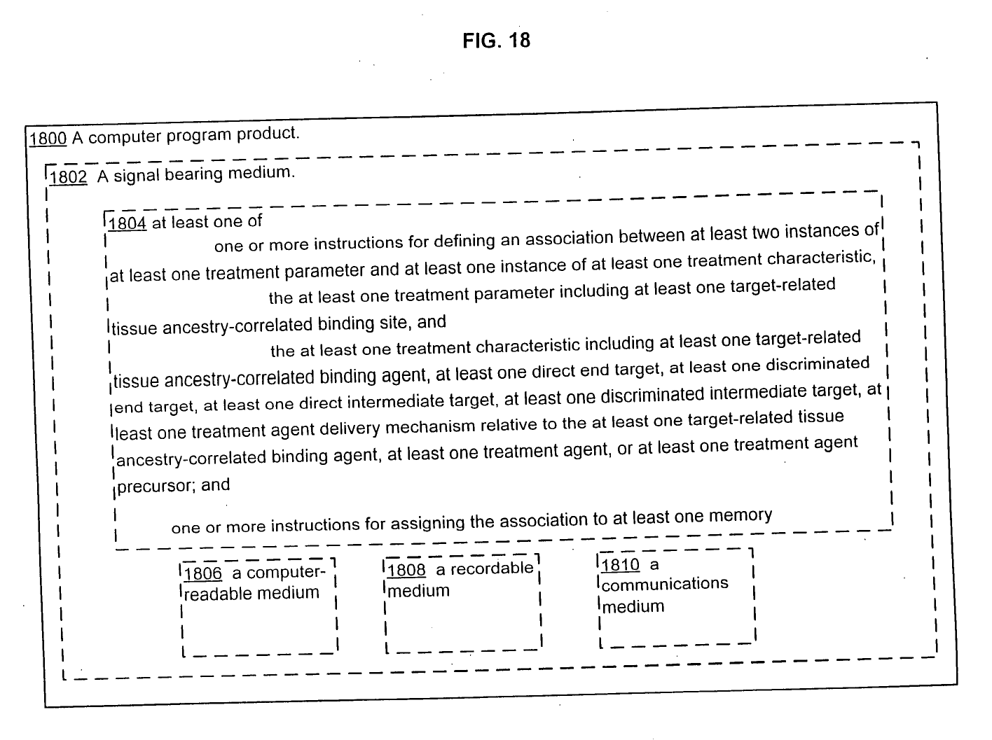

FIG. 18 illustrates a partial view of an example computer program product 1800 that includes a computer program 1804 for executing a computer process on a computing device. An embodiment of the example computer program product 1800 is provided using a signal bearing medium 1802, and may include at least one of one or more instructions for defining an association between at least two instances of at least one treatment parameter and at least one instance of at least one treatment characteristic, the at least one treatment parameter including at least one target-related tissue ancestry-correlated binding site, and the at least one treatment characteristic including at least one target-related tissue ancestry-correlated binding agent, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor, and one or more instructions for assigning the association to at least one memory. The one or more instructions may be, for example, computer-executable and/or logic-implemented instructions. In one implementation, the signal-bearing medium 1802 may include a computer-readable medium 1806. In one implementation, the signal bearing medium 1802 may include a recordable medium 1808. In one implementation, the signal bearing medium 1802 may include a communications medium 1810.

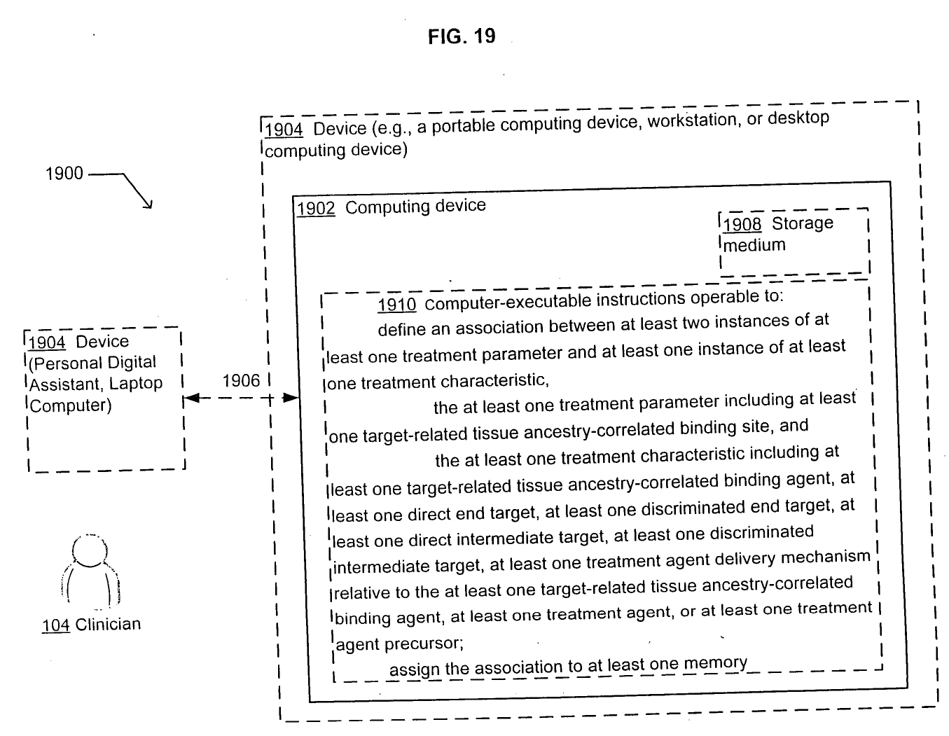

FIG. 19 illustrates an example system 1900 in which embodiments may be implemented. The system 1900 includes a computing system environment. The system 1900 also illustrates the clinician 104 using a device 1904, which is optionally shown as being in communication with a computing device 1902 by way of an optional coupling 1906. The optional coupling 1906 may represent a local, wide-area, or peer-to-peer network, or may represent a bus that is internal to a computing device (e.g., in example embodiments in which the computing device 1902 is contained in whole or in part within the device 1904). A storage medium 1908 may be any computer storage media.

The computing device 1902 includes computer-executable instructions 1910 that when executed on the computing device 1902 cause the computing device 1902 to define an association between at least two instances of at least one treatment parameter and at least one instance of at least one treatment characteristic, the at least one treatment parameter including at least one target-related tissue ancestry-correlated binding site, and the at least one treatment characteristic including at least one target-related tissue ancestry-correlated binding agent, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor, and to assign the association to at least one memory. As referenced above and as shown in FIG. 19, in some examples, the computing device 1902 may optionally be contained in whole or in part within the clinician device 1904.

In FIG. 19, then, the system 1900 includes at least one computing device (e.g., 1902 and/or 1904). The computer-executable instructions 110 may be executed on one or more of the at least one computing device. For example, the computing device 1902 may implement the computer-executable instructions 110 and output a result to (and/or receive data from) the computing (clinician) device 1904. Since the computing device 1902 may be wholly or partially contained within the computing (clinician) device 1904, the device 1904 also may be said to execute some or all of the computer-executable instructions 1 10, in order to be caused to perform or implement, for example, various ones of the techniques described herein, or other techniques.

The clinician device 1904 may include, for example, a portable computing device, workstation, or desktop computing device. In another example embodiment, the computing device 1902 is operable to communicate with the clinician device 1904 associated with the clinician 104 to receive information about the association from the clinician for assigning to the memory.

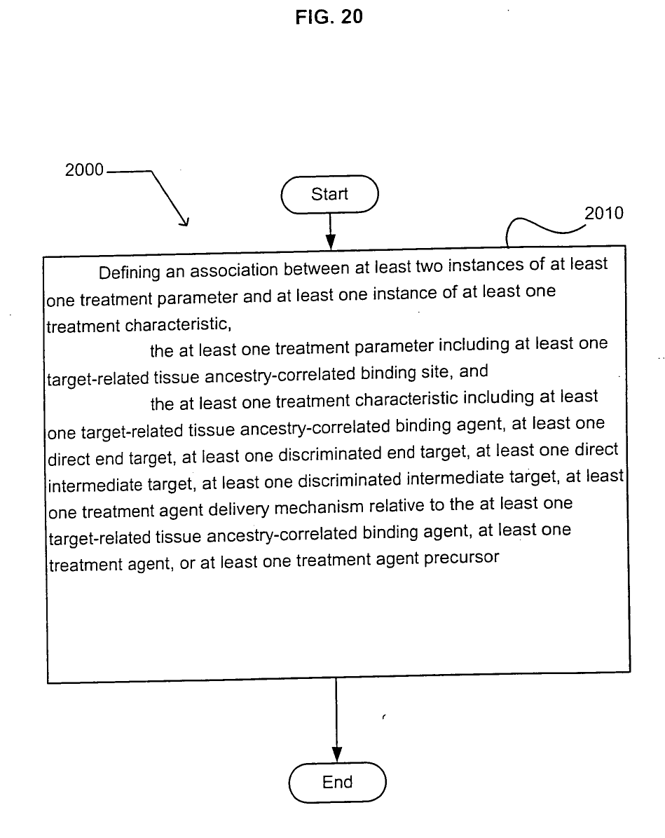

FIG. 20 illustrates an operational flow 2000 representing example operations related to data techniques for tissue coding. In FIG. 20, at an operation 2010, an association is defined between at least two instances of at least one treatment parameter and at least one instance of at least one treatment characteristic, where the at least one treatment parameter includes at least one target-related tissue ancestry-correlated binding site, and where the at least one treatment characteristic includes at least one target-related tissue ancestry-correlated binding agent, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor. For example, as referenced above in detail, such an association may be defined using any two instances of the target-related tissue ancestry-correlated binding site(s) 314 illustrated and/or discussed with respect to FIGS. 1-7, and between any one instance of the treatment characteristics set forth with respect to the operation 2010.

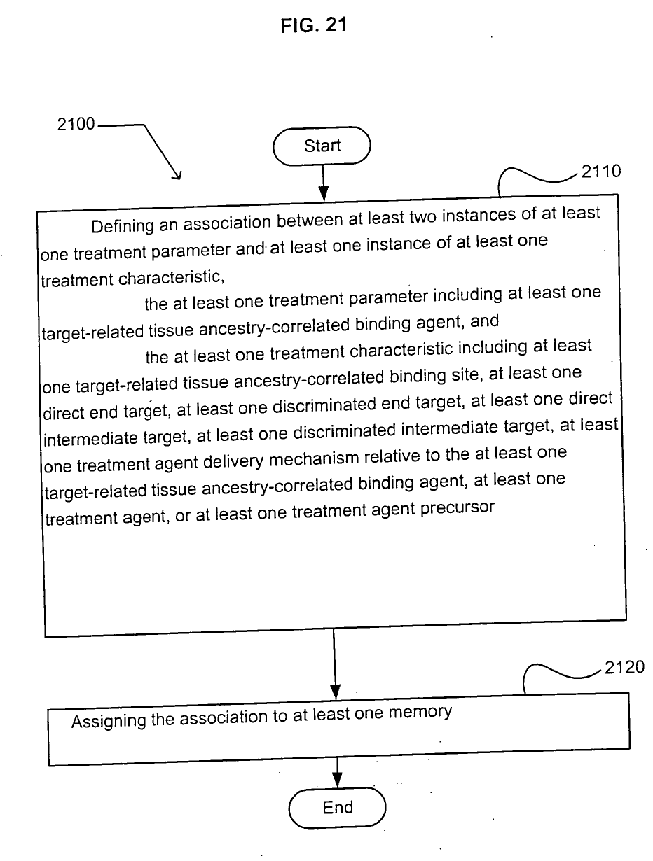

FIG. 21 illustrates an operational flow 2100 representing example operations related to data techniques for tissue coding. After a start operation, the operational flow 21 00 moves to a defining operation 21 1 0 where an association is defined between at least two instances of at least one treatment parameter and at least one instance of at least one treatment characteristic. The at least one treatment parameter includes at least one target-related tissue ancestry-correlated binding agent, and the at least one treatment characteristic includes at least one target-related tissue ancestry-correlated binding site, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor.

For example, the treatment logic 128 of the treatment system 102 may receive a designation of at least two instances of the target-related tissue ancestry-correlated binding agent 316, such as, for example, two or more appropriate (types of) binding I-labeled monoclonal antibodies. These two instances may then be associated within the treatment data 126 with one or more instances of, for example, the target-related tissue ancestry-correlated binding site 314, such as, for example, one or more of the fifteen differentially-expressed proteins referenced in the row 506 of FIG. 5. Of course, the two or more instances of the target-related tissue ancestry-correlated binding agent 316 also may be associated with one or more instances of the other treatment characteristics recited in the operation 8 1 0, such as, for example, one or more radionuclide(s) associated as an instance(s) of the treatment agent 320.

In an assigning operation 2120, the association is then assigned to at least one memory. For example, the association may be assigned to one or more of the various (types of) databases referenced above, such as the relational and/or object-oriented database(s), or to another type of memory, not explicitly mentioned.

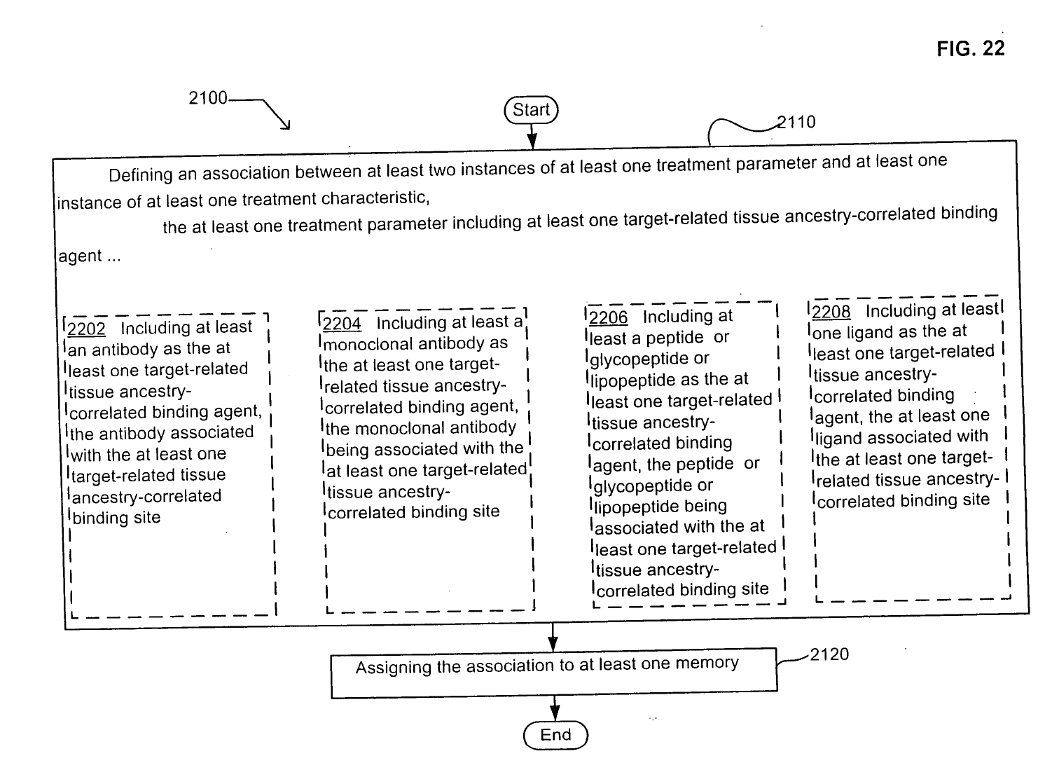

FIG. 22 illustrates an alternative embodiment of the example operational flow of FIG. 21. FIG. 22 illustrates example embodiments where the defining operation 2110 may include at least one additional operation. Additional operations may include operation 2202, operation 2204, operation 2206, and/or operation 2208.

At the operation 2202, at least an antibody is included as the at least one target-related tissue ancestry-correlated binding agent, the antibody associated with the at least one target-related tissue ancestry-correlated binding site. For example, as shown in rows 502, 504, and 506 of FIG. 5, and as shown in the row 702 of FIG. 7, various types of antibodies may be selected as instance(s) of the target-related tissue ancestry-correlated binding agent 316 for association with corresponding instances of the target-related tissue ancestry-correlated binding site 314 (e.g., APP and/or antigen), within the treatment data 126 of the treatment system 102.

At the operation 2204, at least a monoclonal antibody may be included as the at least one target-related tissue ancestry-correlated binding agent, the monoclonal antibody being associated with the at least one target-related tissue ancestry-correlated binding site. For example, as again shown in rows 502, 504, and 506 of FIG. 5, and as shown in the row 702 of FIG. 7, various types of I-labeled monoclonal antibodies may be appropriately selected as instance(s) of the target-related tissue ancestry-correlated binding agent 316 for association with corresponding instances of the target-related tissue ancestry-correlated binding site 314, within the treatment data 126 of the treatment system 102. In this way, the (monoclonal) antibodies may be used to target the corresponding target-related tissue ancestry-correlated binding site(s), for delivery of a desired instance of the treatment agent 320, as described herein.

At the operation 2206, at least a peptide or glycopeptide or lipopeptide may be included as the at least one target-related tissue ancestry-correlated binding agent, the peptide or glycopeptide or lipopeptide being associated with the at least one target-related tissue ancestry-correlated binding site. For example, as shown in the row 602 of FIG. 6, the treatment data 126 may store the CPGPEGAGC peptide as the target-related tissue ancestry-correlated binding agent 316, where the CPGPEGAGC is known to bind to a target-related tissue ancestry-correlated binding site such as APP, e.g., the APP of vascular bed(s) of breast tissue.

At the operation 2208, at least one ligand may be included as the at least one target-related tissue ancestry-correlated binding agent, the at least one ligand associated with the at least one target-related tissue ancestry-correlated binding site. For example, as shown in the row 704 of FIG. 7, the ligand fvII may be used as the target-related tissue ancestry-correlated binding agent 316 for the target-related tissue ancestry-correlated binding site 314 of tissue factor, an association that may be stored within the treatment data 126.

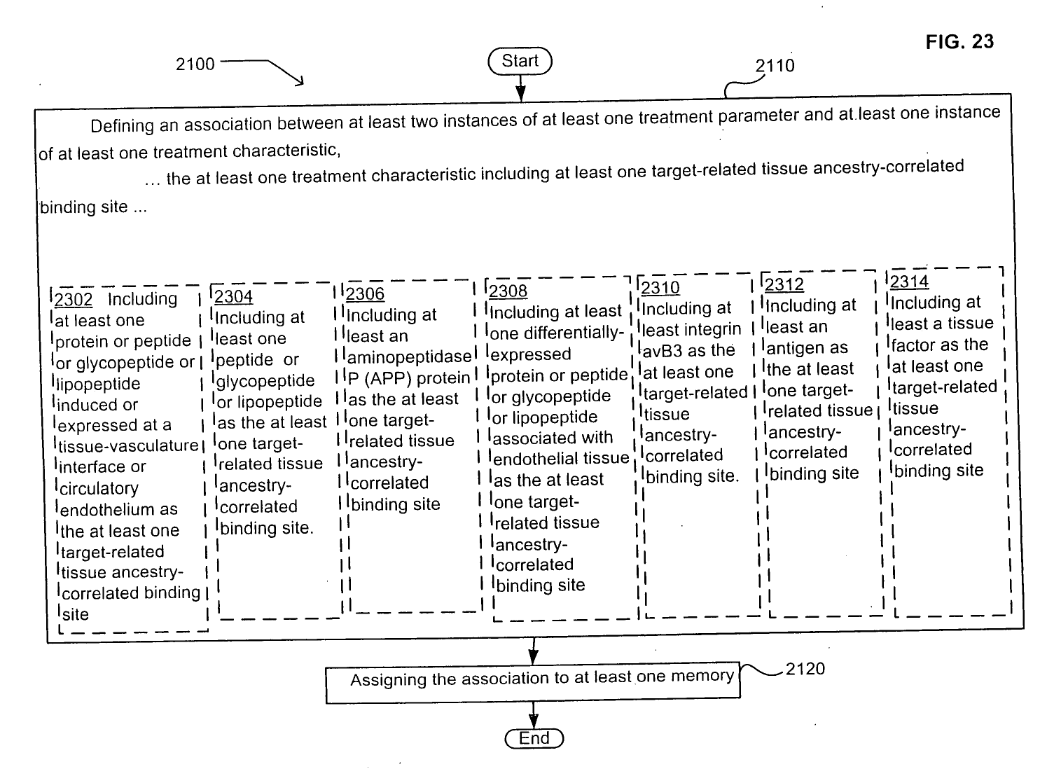

FIG. 23 illustrates an alternative embodiment of the example operational flow of FIG. 21. FIG. 23 illustrates example embodiments where the defining operation 2110 may include at least one additional operation. Additional operations may include operation 2302, operation 2304, operation 2306, operation 2308, operation 2310, operation 2312, and/or operation 2314.

At the operation 2302, at least one protein or peptide or glycopeptide or lipopeptide induced or expressed at a tissue-vasculature interface or circulatory endothelium may be included as the at least one target-related tissue ancestry-correlated binding site. For example, as referenced herein, the treatment data 126 may store a protein induced at an endothelium layer 118 to be used as the target-related tissue ancestry-correlated binding site.

At the operation 2304, at least one peptide or glycopeptide or lipopeptide may be included as the at least one target-related tissue ancestry-correlated binding site. For example, the treatment data 126 may store a peptide as a selected in vivo target for antibodies in specified healthy and/or diseased tissues.

At the operation 2306, at least an aminopeptidase P (APP) protein may be included as the at least one target-related tissue ancestry-correlated binding site. For example, as shown in rows 502 and/or 504 of FIG. 5, APP may be stored in the treatment data 126 as an instance of the target-related tissue ancestry-correlated binding site 314.

At the operation 2308, at least one differentially-expressed protein or peptide or glycopeptide or lipopeptide associated with endothelial tissue may be included as the at least one target-related tissue ancestry-correlated binding site. For example, as shown in the row 506 of FIG. 5, such a differentially-expressed protein or peptide or glycopeptide or lipopeptide may be included as an instance of the target-related tissue ancestry-correlated binding site 314, for targeting thereof with an appropriate antibody and subsequent delivery of the associated/attached treatment agent 320 to diseased lung tissue as an instance of the direct end target 306.

At the operation 2310, at least integrin avB3 may be included as the at least one target-related tissue ancestry-correlated binding site. For example, as shown in the row 604 of FIG. 6, the treatment data 126 may store integrin avB3 as a target for delivering a desired gene to melanoma tumor cells, without delivering the gene to surrounding, non-cancerous cells.

At the operation 2312, at least an antigen may be included as the at least one target-related tissue ancestry-correlated binding site. For example, as shown in the row 702 of FIG. 7, the treatment data 126 may store an antigen to which the monoclonal antibody TX3.833 binds, in order to provide the clinician 104 with information that such an antigen may be used to direct the TX3.833 antibody thereto.

At the operation 2314, at least a tissue factor may be included as the at least one target-related tissue ancestry-correlated binding site. For example, as shown in the row 704 of FIG. 7, the treatment data 126 may store a tissue factor having a known and associated ligand therefore (e.g., fvII).

Additionally, although FIG. 23 is illustrated with respect to (instance(s) of) a target-related tissue ancestry-correlated binding site(s), one skilled in the art will recognize that the two or more instances of at least one treatment parameter(s) (the treatment parameter(s) including at least a target-related tissue ancestry-correlated treatment agent(s)) may be associated with one or more instances of any of the treatment characteristic(s) listed above with respect to FIGS. 21-23, and/or other treatment characteristics, where examples of such treatment characteristics are provided above, for example, with respect to FIGS. 11-17.

In addition to references described above, the following are also hereby incorporated by reference in their entireties to the extent such are not inconsistent herewith:

Pasqualini et al., “Probing the Structural and Molecular Diversity of Tumor Vasculature,” TRENDS in Molecular Medicine, vol. 8, No. 12, pp. 563-571 (December 2002);

Aird et al., “Vascular Bed-specific Expression of an Endothelial Cell Gene is Programmed by the Tissue Microenvironment,” The Journal of Cell Biology, vol. 138, No. 5, pp. 1117-1124 (Sep. 8, 1997);

Pasqualini et al., “Organ Targeting In Vivo Using Phage Display Peptide Libraries,” Nature, vol. 380, pp. 364-366 (Mar. 28, 1996);

Rajotte et al., “Molecular Heterogeneity of the Vascular Endothelium Revealed by In Vivo Phage Display,” J. Clin. Invest., vol. 102, No. 2, pp. 430-437 (July 1998);

M'Rini et al., “A Novel Endothelial L-Selectin Ligand Activity in Lymph Node Medulla That Is Regulated by (1,3)-Fucosyltransferase-IV,” J. Exp. Med., vol. 198, No. 9, pp. 1301-1312 (Nov. 3, 2003);

Carver, et al., “Caveolae: Mining Little Caves for New Cancer Targets,” Nature Reviews, vol. 3, pp. 571-572 (August 2003);

Folkman, Judah, “Looking For A Good Endothelial Address,” Cancer Cell, pp. 113-115 (March 2002);

Brodey, Lawerence C., “Treating Cancer by Targeting a Weakness,” N Engl J Med, 353; 9 pp. 949-950 (1 Sep. 2005);

Farmer et al., “Targeting the DNA Repair Defect in BRCA Mutant Cells as a Therapeutic Strategy,” Nature, vol. 434, pp. 917-921 (14 Apr. 2005);

Bryant et al., “Specific Killing of BRCA2-Deficient Tumours with Inhibitors of poly(ADP-ribose) Polymerase,” Nature, vol. 434, pp. 913-917 (14 Apr. 2005).

While particular aspects of the present subject matter described herein have been shown and described, it will be apparent to those skilled in the art that, based upon the teachings herein, changes and modifications may be made without departing from this subject matter described herein and its broader aspects and, therefore, the appended claims are to encompass within their scope all such changes and modifications as are within the true spirit and scope of this subject matter described herein. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality. Any two components capable of being so associated can also be viewed as being “operably couplable” to each other to achieve the desired functionality. Specific examples of operably couplable include but are not limited to physically mateable and/or physically interacting components and/or wirelessly interactable and/or wirelessly interacting components and/or logically interactable and/or logically interacting components.

While certain features of the described implementations have been illustrated as disclosed herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A treatment system comprising: means for defining an association between at least two instances of at least one treatment parameter and at least one instance of at least one treatment characteristic,
the at least one treatment parameter including at least one target-related tissue ancestry-correlated binding site, and
the at least one treatment characteristic including at least one target-related tissue ancestry-correlated binding agent, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor; and means for assigning the association to at least one memory.

2. The treatment system of claim 1 wherein the means for defining an association between at least two instances of at least one treatment parameter and at least one instance of at least one treatment characteristic, the at least one treatment parameter including at least one target-related tissue ancestry-correlated binding site, comprises:
a memory having at least one protein induced at a tissue-blood interface as the at least one target-related tissue ancestry-correlated binding site.

3. (canceled)

4. The treatment system of claim 1 wherein the means for defining an association between at least two instances of at least one treatment parameter and at least one instance of at least one treatment characteristic, the at least one treatment parameter including at least one target-related tissue ancestry-correlated binding site, comprises:
a memory having at least an aminopeptidase P (APP) protein as the at least one target-related tissue ancestry-correlated binding site.

5. The treatment system of claim 1 wherein the means for defining an association between at least two instances of at least one treatment parameter and at least one instance of at least one treatment characteristic, the at least one treatment parameter including at least one target-related tissue ancestry-correlated binding site, comprises:
a memory having at least one differentially-expressed protein or peptide or glycopeptide or lipopeptide associated with endothelial tissue as the at least one target-related tissue ancestry-correlated binding site.

6. The treatment system of claim 1 wherein the means for defining an association between at least two instances of at least one treatment parameter and at least one instance of at least one treatment characteristic, the at least one treatment parameter including at least one target-related tissue ancestry-correlated binding site, comprises:
a memory having at least integrin avB3 as the at least one target-related tissue ancestry-correlated binding site.

7. The treatment system of claim 1 wherein the means for defining an association between at least two instances of at least one treatment parameter and at least one instance of at least one treatment characteristic, the at least one treatment parameter including at least one target-related tissue ancestry-correlated binding site, comprises:
a memory having at least an antigen as the at least one target-related tissue ancestry-correlated binding site.

8. The treatment system of claim 1 wherein the means for defining an association between at least two instances of at least one treatment parameter and at least one instance of at least one treatment characteristic, the at least one treatment parameter including at least one target-related tissue ancestry-correlated binding site, comprises:
a memory having at least a tissue factor as the at least one target-related tissue ancestry-correlated binding site.

9. The treatment system of claim 1 wherein the means for defining an association between at least two instances of at least one treatment parameter and at least one instance of at least one treatment characteristic, the at least one treatment characteristic including at least one target-related tissue ancestry-correlated binding agent, comprises:
a memory having at least an antibody as the at least one target-related tissue ancestry-correlated binding agent, the antibody being associated with the at least one target-related tissue ancestry-correlated binding site.

10. (canceled)

11. The treatment system of claim 1 wherein the means for defining an association between at least two instances of at least one treatment parameter and at least one instance of at least one treatment characteristic, the at least one treatment characteristic including at least one target-related tissue ancestry-correlated binding agent, comprises:
a memory having at least a peptide or glycopeptide or lipopeptide as the at least one target-related tissue ancestry-correlated binding agent, the peptide or glycopeptide or lipopeptide being associated with the at least one target-related tissue ancestry-correlated binding site.

12. The treatment system of claim 1 wherein the means for defining an association between at least two instances of at least one treatment parameter and at least one instance of at least one treatment characteristic, the at least one treatment characteristic including at least one target-related tissue ancestry-correlated binding agent, comprises:
a memory having at least one ligand as the at least one target-related tissue ancestry-correlated binding agent, the at least one ligand associated with the at least one target-related tissue ancestry-correlated binding site.

13. (canceled)

14. The treatment system of claim 1 wherein the means for defining an association between at least two instances of at least one treatment parameter and at least one instance of at least one treatment characteristic, the at least one treatment characteristic including at least one direct end target, comprises: a memory having one or more of an organ, an organ system, an organ subsystem, diseased tissue, and/or healthy tissue as the at least one direct end target.

15. The treatment system of claim 1 wherein the means for defining an association between at least two instances of at least one treatment parameter and at least one instance of at least one treatment characteristic, the at least one treatment parameter including at least one target-related tissue ancestry-correlated binding site, and the at least one treatment characteristic including at least one direct end target, comprises:
means for determining the at least one direct end target as one that is associated with the at least one target-related tissue ancestry-correlated binding site.

16. (canceled)

17. (canceled)

18. The treatment system of claim 1 wherein the means for defining an association between at least two instances of at least one treatment parameter and at least one instance of at least one treatment characteristic, the at least one treatment characteristic including at least one discriminated end target, comprises:
a memory having one or more of an organ, an organ system, an organ subsystem, diseased tissue, and/or healthy tissue as the at least one discriminated end target.

19. The treatment system of claim 1 wherein the means for defining an association between at least two instances of at least one treatment parameter and at least one instance of at least one treatment characteristic, the at least one treatment characteristic including at least one direct end target, at least one discriminated end target, or at least one treatment agent, comprises:
a memory having the at least one discriminated end target as one that is proximate to the at least one direct end target for the at least one treatment agent.

20. (canceled)

21. (canceled)

22. The treatment system of claim 1 wherein the means for defining an association between at least two instances of at least one treatment parameter and at least one instance of at least one treatment characteristic, the at least one treatment characteristic including at least one direct intermediate target, comprises:
a memory having a vasculature tissue component in contact with circulating blood or a blood component as the at least one direct intermediate target.

23. The treatment system of claim 1 wherein the means for defining an association between at least two instances of at least one treatment parameter and at least one instance of at least one treatment characteristic, the at least one treatment characteristic including at least one direct intermediate target, comprises:
a memory having at least one endothelial cell along a wall of a vasculature as the at least one direct intermediate target.

24. The treatment system of claim 1 wherein the means for defining an association between at least two instances of at least one treatment parameter and at least one instance of at least one treatment characteristic, the at least one treatment characteristic including at least one direct end target or at least one direct intermediate target, comprises:
a memory having at least one endothelial cell along a wall of a vasculature that is proximate to the at least one direct end target as the at least one direct intermediate target.

25. The treatment system of claim 1 wherein the means for defining an association between at least two instances of at least one treatment parameter and at least one instance of at least one treatment characteristic, the at least one treatment parameter including at least one target-related tissue ancestry-correlated binding site, and the at least one treatment characteristic including at least one direct intermediate target, comprises:
a memory having at least one endothelial cell having a property associated with the at least one target-related tissue ancestry-correlated binding site as the at least one direct intermediate target.

26. (canceled)

27. The treatment system of claim 1 wherein the means for defining an association between at least two instances of at least one treatment parameter and at least one instance of at least one treatment characteristic, the at least one treatment characteristic including at least one discriminated intermediate target, comprises:
a memory having non-targeted, tissue ancestry-correlated cells as the at least one discriminated intermediate target.

28. The treatment system of claim 1 wherein the means for defining an association between at least two instances of at least one treatment parameter and at least one instance of at least one treatment characteristic, the at least one treatment characteristic including at least one target-related tissue ancestry-correlated binding agent, or at least one discriminated intermediate target, comprises:
a memory having at least one body system and/or region as the at least one discriminated intermediate target that the at least one target-related tissue ancestry-correlated binding agent is known to avoid with efficacy.

29. The treatment system of claim 1 wherein the means for defining an association between at least two instances of at least one treatment parameter and at least one instance of at least one treatment characteristic, the at least one treatment characteristic including at least one target-related tissue ancestry-correlated binding agent, at least one treatment agent delivery mechanism relative to the at least one target-related tissue ancestry-correlated binding agent, at least one treatment agent, or at least one treatment agent precursor, comprises:
means for determining the at least one treatment agent delivery mechanism relative to the at least one target-related tissue ancestry-correlated binding agent as including direct attachment of the at least one treatment agent and/or the at least one treatment agent precursor to the at least one target-related tissue ancestry-correlated binding agent.

30. The treatment system of claim 1 wherein the means for defining an association between at least two instances of at least one treatment parameter and at least one instance of at least one treatment characteristic, the at least one treatment characteristic including at least one target-related tissue ancestry-correlated binding agent, at least one treatment agent delivery mechanism relative to the at least one target-related tissue ancestry-correlated binding agent, at least one treatment agent, or at least one treatment agent precursor, comprises:
means for determining the at least one treatment agent delivery mechanism relative to the at least one target-related tissue ancestry-correlated binding agent as including indirect attachment of the at least one treatment agent and/or the at least one treatment agent precursor to the at least one target-related tissue ancestry-correlated binding agent, via one or more intermediary structures.

31. The treatment system of claim 1 wherein the means for defining an association between at least two instances of at least one treatment parameter and at least one instance of at least one treatment characteristic, the at least one treatment characteristic including at least one target-related tissue ancestry-correlated binding agent, at least one direct end target, at least one treatment agent delivery mechanism relative to the at least one target-related tissue ancestry-correlated binding agent, at least one treatment agent, or at least one treatment agent precursor, comprises:
means for determining the at least one treatment agent delivery mechanism relative to the at least one target-related tissue ancestry-correlated binding agent as including a mechanism by which the at least one treatment agent and/or the at least one treatment agent precursor may access and/or affect the at least one direct end target.

32. The treatment system of claim 1 wherein the means for defining an association between at least two instances of at least one treatment parameter and at least one instance of at least one treatment characteristic, the at least one treatment characteristic including at least one treatment agent, comprises: a memory having the at least one treatment agent as one that modulates a function of a cell in a useful and/or desired manner.

33. (canceled)

34. The treatment system of claim 1 wherein the means for defining an association between at least two instances of at least one treatment parameter and at least one instance of at least one treatment characteristic, the at least one treatment characteristic including at least one treatment agent, comprises: a memory having the at least one treatment agent as one that delivers radio-immunotherapy or therapy that enhances repair of damaged DNA or therapy that suppresses repair of damaged DNA.

35. The treatment system of claim 1 wherein the means for defining an association between at least two instances of at least one treatment parameter and at least one instance of at least one treatment characteristic, the at least one treatment characteristic including at least one treatment agent, comprises: a memory having at least one radionuclide or DNA repair-modulating agent or pro- or anti-apoptotic agent as the at least one treatment agent.

36. The treatment system of claim 1 wherein the means for defining an association between at least two instances of at least one treatment parameter and at least one instance of at least one treatment characteristic, the at least one treatment parameter including at least one target-related tissue ancestry-correlated binding site, and the at least one treatment characteristic including at least one treatment agent precursor, comprises:
a memory having an immune-response element as the at least one treatment agent precursor that is known to attach selectively to the at least one target-related tissue ancestry-correlated binding site.

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. A treatment system comprising: means for defining an association between at least two instances of at least one treatment parameter and at least one instance of at least one treatment characteristic,
the at least one treatment parameter including at least one target-related tissue ancestry-correlated binding agent, and
the at least one treatment characteristic including at least one target-related tissue ancestry-correlated binding site, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor; and means for assigning the association to at least one memory.

51. The treatment system of claim 50 wherein the means for defining an association between at least two instances of at least one treatment parameter and at least one instance of at least one treatment characteristic, the at least one treatment parameter including at least one target-related tissue ancestry-correlated binding agent, comprises:
a memory having at least an antibody as the at least one target-related tissue ancestry-correlated binding agent, the antibody associated with the at least one target-related tissue ancestry-correlated binding site.

52. (canceled)

53. The treatment system of claim 50 wherein the means for defining an association between at least two instances of at least one treatment parameter and at least one instance of at least one treatment characteristic, the at least one treatment parameter including at least one target-related tissue ancestry-correlated binding agent, comprises:
a memory having at least a peptide or glycopeptide or lipopeptide as the at least one target-related tissue ancestry-correlated binding agent, the peptide or glycopeptide or lipopeptide being associated with the at least one target-related tissue ancestry-correlated binding site.

54. The treatment system of claim 50 wherein the means for defining an association between at least two instances of at least one treatment parameter and at least one instance of at least one treatment characteristic, the at least one treatment parameter including at least one target-related tissue ancestry-correlated binding agent, comprises:
a memory having at least one ligand as the at least one target-related tissue ancestry-correlated binding agent, the at least one ligand associated with the at least one target-related tissue ancestry-correlated binding site.

55. The treatment system of claim 50 wherein the means for defining an association between at least two instances of at least one treatment parameter and at least one instance of at least one treatment characteristic, the at least one treatment characteristic including at least one target-related tissue ancestry-correlated binding site, comprises:
a memory having at least one protein or peptide or glycopeptide or lipopeptide induced or expressed at a tissue-vasculature interface or circulatory endothelium as the at least one target-related tissue ancestry-correlated binding site.

56. The treatment system of claim 50 wherein the means for defining an association between at least two instances of at least one treatment parameter and at least one instance of at least one treatment characteristic, the at least one treatment characteristic including at least one target-related tissue ancestry-correlated binding site, comprises:
a memory having at least one peptide or glycopeptide or lipopeptide as the at least one target-related tissue ancestry-correlated binding site.

57. The treatment system of claim 50 wherein the means for defining an association between at least two instances of at least one treatment parameter and at least one instance of at least one treatment characteristic, the at least one treatment characteristic including at least one target-related tissue ancestry-correlated binding site, comprises:
a memory having at least an aminopeptidase P (APP) protein as the at least one target-related tissue ancestry-correlated binding site.

58. (canceled)

59. The treatment system of claim 50 wherein the means for defining an association between at least two instances of at least one treatment parameter and at least one instance of at least one treatment characteristic, the at least one treatment characteristic including at least one target-related tissue ancestry-correlated binding site, comprises:
a memory having at least integrin avB3 as the at least one target-related tissue ancestry-correlated binding site.

60. The treatment system of claim 50 wherein the means for defining an association between at least two instances of at least one treatment parameter and at least one instance of at least one treatment characteristic, the at least one treatment characteristic including at least one target-related tissue ancestry-correlated binding site, comprises:
a memory having at least an antigen as the at least one target-related tissue ancestry-correlated binding site.

61. The treatment system of claim 50 wherein the means for defining an association between at least two instances of at least one treatment parameter and at least one instance of at least one treatment characteristic, the at least one treatment characteristic including at least one target-related tissue ancestry-correlated binding site, comprises:
a memory having at least a tissue factor as the at least one target-related tissue ancestry-correlated binding site.

62. A computer program product comprising: a signal-bearing medium bearing at least one of
(a) one or more instructions for defining an association between at least two instances of at least one treatment parameter and at least one instance of at least one treatment characteristic,
the at least one treatment parameter including at least one target-related tissue ancestry-correlated binding agent, and
the at least one treatment characteristic including at least one target-related tissue ancestry-correlated binding site, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor, and
(b) one or more instructions for assigning the association to at least one memory.
